(19) United States
(12) Patent Application Publication
(10) Pub. No.: US 2007/0110395 A1
(43) Pub. Date: May 17, 2007

(54) Apparatus and method of content recording/playback

(76) Inventors: Takanori Ishida, Ibaraki-shi (JP); Etsuto Nakatsu, Katano-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/556,707

(22) PCT Filed: May 12, 2004
(86) PCT No.: PCT/JP04/06717

§ 371 Date: Nov. 10, 2005

(30) Foreign Application Priority Data
May 13, 2003 (JP) 2003-133931

(51) Int. Cl. H04N 7/00

(52) U.S. Cl. 386/95; 386/1

(57) ABSTRACT

A content recording/playback apparatus includes: a first medium management section for reading the encoded content from the first medium; a decoder for decoding the encoded content having been read, and outputting a decoded content; a control section for receiving and outputting at least the decoded content having been output from the decoder; a display section for reproducing the decoded content having been output from the control section; and a second medium management section for, if the encoded content is recordable to the second medium, receiving the encoded content which has been read by the first medium management section, and recording the encoded content onto the second medium, during reproduction of the decoded content by the display section. As a result, the waiting time until finishing coping onto the other storage medium can be reduced.

### TECHNICAL FIELD

The present invention relates to a technique of recording a content to be played back, which contains video, audio, etc., onto a storage medium such as an optical disk or a magnetic disk.

### BACKGROUND ART

Conventionally, content recording/playback apparatuses have been known which can record and playback contents by using a hard disk drive that utilizes a magnetic disk as a storage medium, or using an optical disk apparatus that utilizes a large-capacity rewritable-type DVD (Digital Versatile Disc) as a storage medium.

Among the content recording/playback apparatuses of the recent years, there have been developed combination-type apparatuses which make it possible to, with a single apparatus, record contents on either one of different types of storage media, e.g., a magnetic disk and an optical disk, and reproduce recorded contents therefrom. For example, Japanese Laid-Open Patent Publication No. 2001-344898 describes a content recording/playback apparatus which records a content on a given storage medium, while simultaneously recording the same content on another storage medium. This content recording/playback apparatus records the same content on all storage media within the apparatus. Then, when it becomes necessary to copy a content which is recorded on a storage medium to another storage medium, it would appear that recording for all storage media is completed instantaneously.

When copying a content recorded on a storage medium to another storage medium, a combination-type content recording/playback apparatuses of the recent years allows the user to select a content to be recorded in a situation where no contents are under reproduction/playback.

In a conventional content recording/playback apparatus, since the same content is to be recorded on all storage media within the apparatus, the user is not able to select a content to be copied or only a portion thereof.

Furthermore, when a conventional content recording/playback apparatus is used to copy a content which has been recorded on a storage medium to another storage medium, it is necessary to stop not only any recording operations for the content, but also any reproduction/playback operations. This means that a user who is currently performing a reproduction/playback of a content must first end the reproduction/playback, which would be inconvenient. On the other hand, if a recording of a content onto another storage medium is begun after completing the reproduction/playback of the content, a long waiting time will be required until completion of the recording.

An objective of the present invention is to, in a content recording/playback apparatus having a plurality of storage media, reduce the user's waiting time until a recording onto another storage medium is finished: e.g., while continuing reproduction/playback of a content which is recorded on a storage medium, record that content onto another storage medium.

### DISCLOSURE OF INVENTION

A content recording/playback apparatus according to the present invention copies onto a second medium at least one portion of an encoded content recorded on a first medium. The content recording/playback apparatus comprises: a first medium management section for reading the encoded content from the first medium based on a reading instruction signal; a decoder for decoding the encoded content having been read by the first medium management section, and outputting a decoded content; a control section for controlling a read of the encoded content by generating the reading instruction signal, and receiving and outputting at least the decoded content having been output from the decoder; a display section for reproducing the decoded content having been output from the control section; and a second medium management section for, if the encoded content is recordable to the second medium, receiving the encoded content having been read by the first medium management section and recording the encoded content onto the second medium, during reproduction of the decoded content by the display section. Thus, the above objective is met.

The content recording/playback apparatus may copy from the beginning to end of the encoded content onto the second medium unless there is a designation of a range to be copied of the encoded content.

The content recording/playback apparatus may further comprise a receiving section for, during reproduction of the decoded content by the display section, receiving from a user a starting instruction for starting copying and a position specifying instruction concerning a start position of copying, wherein, based on the starting instruction and the position specifying instruction, the control section may generate a reading instruction signal for instructing on a read position of the encoded content and instructing to start reading the encoded content; and based on the reading instruction signal, the first medium management section may read the encoded content from the read position as instructed.

The receiving section may receive a position specifying instruction for specifying a beginning position of the encoded content as the start position of copying.

The receiving section may receive a position specifying instruction for specifying a currently-reproduced position in the encoded content as the start position of copying.

The encoded content may include an unreproduced portion corresponding to from the copy starting position to a last position and an already-reproduced portion from the beginning position to the copy starting position for which reproduction has been finished; and the control section may generate a first reading instruction signal for instructing to read the unreproduced portion, and generates a second reading instruction signal for instructing to read the already-reproduced portion after reading of the unreproduced portion is finished; the first medium management section may read the unreproduced portion based on the first reading instruction signal, and thereafter reads the already-reproduced portion based on the second reading instruction signal; the decoder may decode and output the unreproduced portion having been read as the decoded content; and the control section may receive the unreproduced portion having been read and outputs the unreproduced portion to the second medium management section, and thereafter receives the already-reproduced portion having been read and outputs the already-reproduced portion to the second medium management section.

The encoded content may include an unreproduced portion corresponding to from the copy starting position to a last position of the encoded content and an already-reproduced portion from the beginning position to the copy starting position of the encoded content for which reproduction has been finished; the control section may generate a first reading instruction signal for instructing to read a first data amount of the unreproduced portion, and after a read based on the first reading instruction signal is finished, generates a second reading instruction signal for instructing to read a second data amount of the already-reproduced portion, the control section repetitively generating the first reading instruction signal and the second reading instruction signal until reads of all of the unreproduced portion and the already-reproduced portion are finished; the first medium management section may read the unreproduced portion based on the first reading instruction signal, and reads the already-reproduced portion based on the second reading instruction signal; the decoder may decode the unreproduced portion having been read by the first medium management section, and outputs the unreproduced portion as the decoded content; and the control section may receive the unreproduced portion having been read and outputs the unreproduced portion to the second medium management section, and thereafter receives the already-reproduced portion having been read and outputs the already-reproduced portion to the second medium management section.

The content recording/playback apparatus may further comprise an encoder for encoding the decoded content, wherein, the decoder may decode the encoded content based on attribute information which represents a first attribute of the encoded content recorded on the first medium, and output the decoded content; and if the encoded content is not recordable to the second medium, the encoder may encode the decoded content to generate an encoded content having a second attribute which is different from the first attribute, and output the encoded content to the second medium management section.

The control section may calculate a copy time to be required for copying, based on, in the at least one portion of the encoded content to be copied, a data amount of a portion whose copying to the second medium has not been completed, and on a write rate to the second storage medium; and the display section may display a remaining time until completion of copying based on the copy time.

The control section may further calculate a reproduction remaining time to be required for reproducing to the end the decoded content under reproduction, and display whichever is longer between the reproduction remaining time and the copy time as the remaining time until completion of copying.

A content recording/playback method according to the present invention method copies onto a second medium at least one portion of an encoded content recorded on a first medium. The content recording/playback method may comprise the steps of: generating a reading instruction signal; reading the encoded content from the first medium based on the reading instruction signal; decoding the encoded content having been read, and generating a decoded content; reproducing the generated decoded content; and recording the encoded content onto the second medium during reproduction of the decoded content, if the encoded content is recordable to the second medium. Thus, the above objective is met.

The step of recording may record from the beginning to end of the encoded content onto the second medium unless there is a designation of a range to be copied of the encoded content.

The method may further comprise the steps of: receiving from a user, during reproduction of the decoded content, a starting instruction for starting copying and a position specifying instruction concerning a start position of copying; and generating a reading instruction signal for instructing on a read position of the encoded content and instructing to start reading the encoded content, based on the instruction and the position specifying instruction, and the step of reading may reads the encoded content from the read position as instructed, based on the reading instruction signal.

The step of receiving the position specifying instruction may receive a position specifying instruction for specifying a beginning position of the encoded content as the start position of copying.

The step of receiving the position specifying instruction may receive a position specifying instruction for specifying a currently-reproduced position in the encoded content as the start position of copying.

The encoded content may include an unreproduced portion corresponding to from the copy starting position to a last position and an already-reproduced portion from the beginning position to the copy starting position for which reproduction has been finished, and the method may further comprise the steps of: generating a first reading instruction signal for instructing to read the unreproduced portion; reading the unreproduced portion based on the first reading instruction signal; generating a second reading instruction signal for instructing to read the already-reproduced portion, after the unreproduced portion has been read; and reading the already-reproduced portion based on the second reading instruction signal, after the unreproduced portion has been read, wherein, the step of generating the decoded content may decode the unreproduced portion having been read and generate the decoded content; and the step of recording onto the second medium may record the already-reproduced portion having been read.

The encoded content may include an unreproduced portion corresponding to from the copy starting position to a last position of the encoded content and an already-reproduced portion from the beginning position to the copy starting position of the encoded content for which reproduction has been finished, and the content recording/playback method may further comprise the steps of: generating a first reading instruction signal for instructing to read a first data amount of the unreproduced portion; reading the first data amount of the unreproduced portion based on the first reading instruction signal; generating a second reading instruction signal for instructing to read a second data amount of the already-reproduced portion, after the unreproduced portion has been read; repeating the step of generating the first reading instruction signal and the step of generating the second reading instruction signal until reads of all of the unreproduced portion and the already-reproduced portion are finished, wherein, the step of generating the decoded content may decode the first data amount of the unreproduced portion having been read and may generate the decoded content; and the step of recording onto the second medium may record the second data amount of the already-reproduced portion having been read.

The content recording/playback method may further comprise the steps of: decoding the encoded content based on attribute information which represents a first attribute of the encoded content, and outputting the decoded content for recording, if the encoded content is not recordable to the second medium; and encoding the decoded content for recording to generate an encoded content having a second attribute which is different from the first attribute, wherein the step of recording may record the encoded content having the second attribute onto the second medium.

The content recording/playback method may further comprise the steps of: calculating a copy time to be required for copying, based on, in the at least one portion of the encoded content to be copied, a data amount of a portion whose copying to the second medium has not been completed, and on a write rate to the second storage medium; and displaying a remaining time until completion of copying based on the copy time.

The step of calculating may further calculate a reproduction remaining time to be required for reproducing to the end the decoded content under reproduction; and the step of displaying may display whichever is longer between the reproduction remaining time and the copy time as the remaining time until completion of copying.

A content recording/playback program according to the present invention is executable on a content recording/playback apparatus which copies at least a portion of an encoded content recorded on a first medium onto a second medium. The content recording/playback program comprises the steps of: generating a reading instruction signal, reading the encoded content from the first medium based on the reading instruction signal, decoding the encoded content having been read to generate a decoded content, reproducing the decoded content having been generated, and recording the encoded content onto the second medium during reproduction of the decoded content. Thus, the above objective is met. Such a content recording/playback program may be recorded on a storage medium.

According to the present invention, when the content recording/playback apparatus is instructed to record a content that is recorded on a storage medium onto another storage medium during reproduction/playback, the control section performs a data read of an playback-completed portion at the start of content recording in a period during which a data read of the content for reproduction/playback is not performed, while giving priority to a data read of the content for reproduction/playback. Then, the data which has been read is used for reproduction/playback, as well as for recording onto a storage medium at the recording destination, and the data which is read in a period during which a data read of the content for reproduction/playback is not performed is recorded as it is to the storage medium at the recording destination. As a result, while continuing reproduction/playback, the content can be recorded onto the storage medium at the recording destination. Moreover, the waiting time from completion of reproduction/playback until completion of recording can be reduced.

When a user instructs the content recording/playback apparatus of the present invention to record a content that is recorded on a storage medium onto another storage medium during reproduction/playback of the content, the control section performs a data read from the beginning of the content in a period during which a data read of the content for playback/reproduction is not performed, while giving priority to a data read of the content for reproduction/playback. Then, the data which is read in idle time during which a data read of the content for reproduction/playback is not performed is recorded onto another storage medium. As a result, while continuing playback/reproduction, the content can be recorded onto the storage medium at the recording destination. Moreover, in the case where the performances of the storage media at both the recording source and the recording destination are sufficiently high, the recording of the content can be completed during the reproduction/playback of the content.

When a user instructs the content recording/playback apparatus of the present invention to record a content that is recorded on a storage medium onto another storage medium during reproduction/playback of the content, the control section retains the beginning read position of the content, a read position for reproduction/playback at the start of recording, and a write beginning position for the storage medium at the recording destination, and based on such information, uses for reproduction/playback the data which has been read for reproduction/playback. The control section concurrently uses this data for recording, and after reproduction/playback is completed, performs a recording of the playback-completed portion at the start of recording. As a result, even with a storage medium having a low writing performance and reading performance, the content recording/playback apparatus can record the content onto the storage medium at the recording destination while continuing reproduction/playback of the content. In this case, the waiting time from completion of reproduction/playback until completion of recording is the elapsed time from start of reproduction/playback until start of recording.

When a user instructs the content recording/playback apparatus of the present invention to record a content that is recorded on a storage medium onto another storage medium during reproduction/playback of the content, the control section re-encodes the content in accordance with the capacity and compression/encoding scheme of the content and the type and vacant capacity of the storage medium at the recording destination, and records it onto the storage medium at the recording destination. As a result, even if storage media of different content compression/encoding schemes and different types are present, the data that is recorded on one of the storage media can be recorded onto another storage medium.

According to the present invention, a program for processing contents that are recorded on a plurality of storage media by using a computer is provided. By utilizing this program, the above-described content recording processes can be realized even with a general-purpose computer. Furthermore, even a conventional content recording/playback apparatus may be updated to this program in order to realize the aforementioned content recording processes.

### BRIEF DESCRIPTION OF DRAWINGS

FIG. 1 is a block diagram showing the structure of a content recording/playback apparatus according to Embodiment 1.

FIG. 2 is a flowchart showing the procedure of a content copying process executed by a content recording/playback apparatus.

FIG. 3 is a diagram showing access timing when the content recording/playback apparatus of Embodiment 1 accesses a storage medium.

FIG. 4 is a flowchart showing the flow of a process in which, while continuing a reproduction/playback of a content, the content is recorded onto a second storage medium 11.

FIG. 5 is a flowchart showing the flow of a first interruption process when a content recording/playback apparatus receives an interrupting instruction.

FIG. 6 is a flowchart showing the flow of a second interruption process when a content recording/playback apparatus receives an interrupting instruction.

FIG. 7 is a flowchart showing the flow of a resume process from a reproduction/playback paused state.

FIG. 8 is a flowchart showing the flow of a third interruption process when a content recording/playback apparatus receives an interrupting instruction.

FIG. 9 is a diagram showing data whose normal-speed reproduction/playback is skipped due to fast-forward.

FIG. 10 is a diagram showing access timing when a content recording/playback apparatus of Embodiment 2 accesses a storage medium.

FIG. 11 is a flowchart showing the flow of a recording process of the content recording/playback apparatus of Embodiment 2.

FIG. 12 is a diagram showing access timing when a content recording/playback apparatus of Embodiment 3 accesses a storage medium.

FIG. 13 is a flowchart showing the flow of a recording process of the content recording/playback apparatus of Embodiment 3.

FIG. 14 is a block diagram showing the structure of a content recording/playback apparatus 2 of Embodiment 4.

FIG. 15 is a diagram showing access timing when the content recording/playback apparatus of Embodiment 4 accesses a storage medium.

FIG. 16 is a flowchart showing the flow of a recording process of the content recording/playback apparatus 2 of Embodiment 4.

FIG. 17 is a diagram showing the structure of a decoder 3 for decoding a plurality of encoded data streams.

### BEST MODE FOR CARRYING OUT THE INVENTION

Hereinafter, with reference to the accompanying drawings, embodiments of content recording/playback apparatuses according to the present invention will be described.

### Embodiment 1

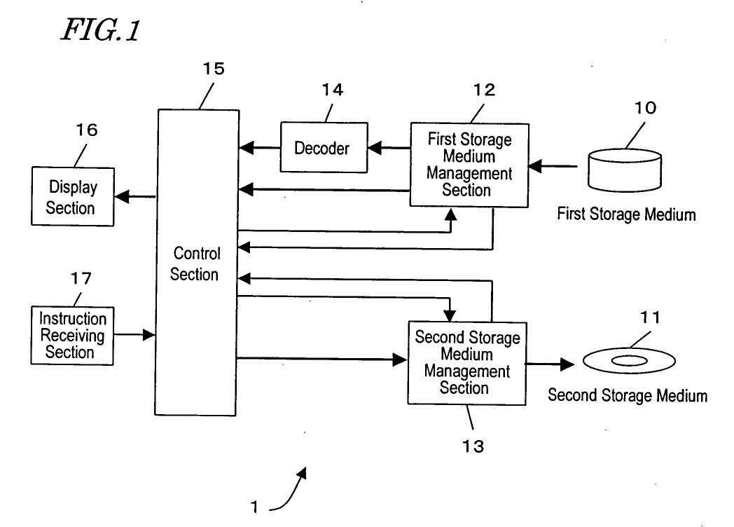

FIG. 1 is a block diagram showing the structure of a content recording/playback apparatus 1 according to the present embodiment. The content recording/playback apparatus 1 includes a first storage medium 10, a second storage medium 11, a first storage medium management section 12, a second storage medium management section 13, a decoder 14, a control section 15, a display section 16, and an instruction receiving section 17.

As shown in FIG. 1, the content recording/playback apparatus 1 is a combination-type apparatus which is capable of recording contents on two types of storage media. Herein, a “content” is the substance of information to be played back, e.g., a broadcast program, a movie, or a piece of music. In the present specification, a “content” includes not only the substance of information to be displayed as video and output as audio or the like that is recognized by human perception, but also the substance of information which has been converted, for the sake of recording onto a storage medium, transmission, or the like, by an electronic method or a magnetic method or any other method which does not permit recognition by human perception. For example, a content may be in the form of video to be displayed on a display, audio to be output from a loudspeaker, or video data and/or audio data which has been compression/encoded by an information compression scheme such as MPEG-2 (Moving Picture Experts Group Phase 2). In the case where a content is in data form, attribute information which represents attributes such as compression/encoding method, a bit rate, and the like is to be further added to the content. Based on the substance of the attribute information, an apparatus which plays back a content is able to decode a content and reproduce the content.

One of the features of the content recording/playback apparatus 1 of the present embodiment is the ability to dub (copy) a whole or part of a content recorded on the first storage medium 10 onto the second storage medium 11, even during reproduction of the content. Note that, in the absence of a designation of a range to be copied (including instructions such as stop copying), the content recording/playback apparatus 1 copies from the beginning to end of a content, in principle. Hereinafter, the constituent elements of the content recording/playback apparatus 1 will be described, and then the operation of the content recording/playback apparatus 1 related to the aforementioned feature will be described.

Firstly, the first storage medium 10 is a storage medium that is capable of random access, and in the present embodiment is assumed to be a hard disk, which is a magnetic storage medium. On the hard disk, a content A to be played back by a user, which is encoded by an encoding scheme such as MPEG-2, is recorded. The notion of the first storage medium 10 may encompass, not only the very hard disk itself on which a content A is recorded, but also a hard disk drive which comprises a mechanism for moving an access arm to a designated position on the hard disk, recording data at that position, and reading data from that position.

The second storage medium 11 is a storage medium that is capable of random access, and is herein assumed to be a rewritable-type DVD (Digital Versatile Disc), which is an optical storage medium. Similarly to the first storage medium 10, the notion of the second storage medium 11 may also encompass, not only the very DVD on which a content is recorded, but also a DVD drive which comprises a mechanism for moving an optical head to a designated position on the DVD, recording data at the position, and reading data from that position.

In the present embodiment, it is assumed that the compression/encoding schemes for the contents recorded on the first storage medium 10 and on the second storage medium 11 are identical. For example, in the case where the first storage medium 10 is a hard disk and the second storage medium 11 is a rewritable-type DVD, the encoding scheme for any content to be recorded is MPEG-2 PS (Program Stream). In another example, where the first storage medium 10 is a hard disk and the second storage medium 11 is a BD (Blue-ray Disc), the encoding scheme for any content to be recorded is MPEG-2 TS (Transport Stream). However, this is only a convenient assumption; it would also be possible to convert a so-called HD broadcast content which has been recorded by MPEG-2 TS to MPEG-2 PS, and record it on a DVD.

The first storage medium management section 12 keeps under management the read positions for data from the first storage medium 10. When writing data to the first storage medium 10, the first storage medium management section 12 is also able to keep the write positions under management. The first storage medium management section 12 receives a reading instruction signal from the control section 15, and based on this signal, reads a content A from a predetermined position on the first storage medium 10. The first storage medium management section 12 outputs the content A having been read to the decoder 14 and the control section 15.

The second storage medium management section 13 keeps under management the data write positions for the second storage medium 11. When reading data from the second storage medium 11, the second storage medium management section 13 is also able to keep the read positions under management. The second storage medium management section 13 receives a writing instruction signal and a content from the control section 15, and based on this signal, records the received content at a predetermined position on the second storage medium 11.

Note that, in the following descriptions, the control section 15 may be said to perform a read or write of a content A. This is in order to avoid length expressions; in practice, the storage medium management section 12 or 13 performs a read or write process.

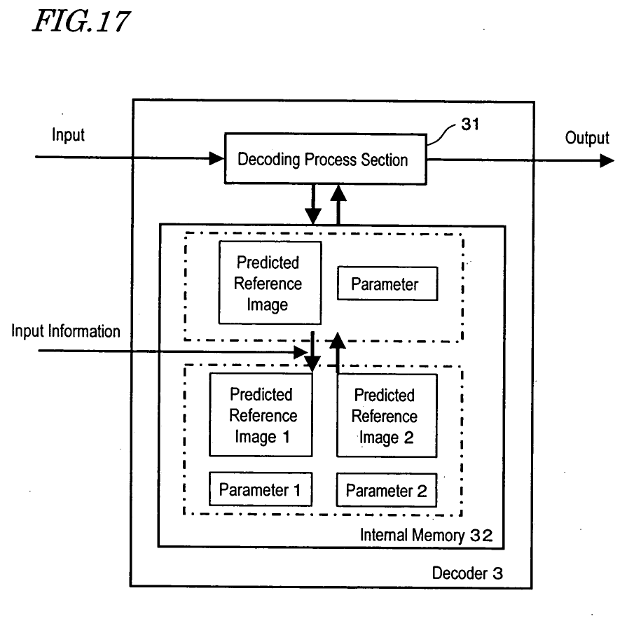

Based on the attribute information, the decoder 14 decodes the content A having been read from the first storage medium 10, and outputs the content which has been decoded (hereinafter referred to as the “decoded content”). The attribute information is to be added to a content which is encoded (hereinafter referred to as an “encoded content”), and represents a compression/encoding method and a bit rate of the content, for example. The decoder 14 is implemented in hardware form, e.g., as an MPEG2 decode circuit. Although it is contemplated that the decoder 14 has a commonly-available decoding process function of receiving and decoding a single encoded data stream, it may be arranged so as to perform decoding of a plurality of encoded data streams, as will be described with reference to FIG. 17.

The control section 15 controls the respective constituent elements of the content recording/playback apparatus 1 so as to control the overall operation of the content recording/playback apparatus 1. More specifically, the control section 15 generates a reading instruction signal which designates, for example, a reading command for a content A, a read position on the first storage medium 10, sends it to the first storage medium management section 12, and causes the first storage medium management section 12 to read the content A that is recorded on the first storage medium 10. Then, based on the reading instruction signal, the control section 15 receives the encoded content A which has been read from the first storage medium management section 12, as well as the decoded content which has been output from the decoder 14. The control section 15 sends the respective received contents to the display section 16 or to the second storage medium management section 13. Furthermore, based on an instruction from the user received at the instruction receiving section 17, the control section 15 performs a copy of the content from the first storage medium 10 to the second storage medium 11. The operation of the control section 15 concerning the copying process will be described later in connection with the operation of the content recording/playback apparatus 1.

Now, it will be described how a read position (address) is to be specified in order for the control section 15 to read data from the hard disk.

A data stream of the content A is unlikely to be recorded in continuous fashion on the hard disk from its beginning to end, but is generally divided in predetermined data units and recorded in discontinuous regions. Each data unit is recorded in continuous fashion. Since efficiency is regarded as important, data reading is performed on data unit basis. In the case where the data stream is MPEG-2PS, for example, this data unit corresponds to a video object unit (VOBU).

In order that data is to be read from the beginning of each data unit, it does not suffice to merely retain a position to which reading has progressed so far, but it is also necessary to acquire the beginning address of each unit by another method. Therefore, the control section 15 specifies the beginning address of each unit by utilizing management information of the data stream of the content A.

In the aforementioned MPEG-2PS, a video object (VOB) is defined as a data sequence having one or more VOBUs. For example, a VOB is generated as one video record program (content).

In the case where the recording is made to a DVD-RAM in the DVD video recording format, a file in which the data stream is stored and a management information file are a VR_MOVIE.VRO″ file and a VR_MANGR.IFO″ file, respectively. In the management information file “VR_MANGR.IFO”, management information is defined in VOB units. For example, in management information corresponding to a content (VOB) which is being currently played back, the address of the beginning portion of each VOBU contained in the content and the data size of that VOBU are described.

In accordance with the aforementioned management information, the control section 15 can surely specify the beginning position of a next VOBU by updating the information that indicates up to which VOBU a read has been completed, and referring to the VOB based on such information. The management information is recorded in the management information file, which is separate from the file in which the data stream is stored, and can be read in advance and stored in a buffer or the like.

In the case where the data stream is to be recorded on the hard disk, the data stream does not need to have the same file structure as that of the aforementioned file(s) because it is unnecessary to consider reproduction compatibility on any other apparatus. Therefore, if there exists management information which can specify an address based on predetermined data units of the data stream, it will be possible to reproduce from the beginning of a data unit based on a similar principle. For example, a storing address of the data can also be specified by utilizing management information which keeps under management the reproduction time and addresses of a data stream.

Next, the display section 16 reproduces and displays, as video or the like, the decoded content having been output from the control section 15. As a result, the playback is made available to the user. The display section 16 may further make a display related to a copy operation of the content recording/playback apparatus 1, e.g., a message to a user such as “Copy to DVD from position currently under reproduction/playback?”, “Yes”, “No”, etc. Note that the display section 16 is not necessarily intended to only display video, but also encompasses a loudspeaker or the like which outputs audio that is included in the content.

The instruction receiving section 17 is an operation button which is provided on the main body of the content recording/playback apparatus 1, or a light-receiving portion for receiving infrared from a remote controller, for receiving an instruction from a user to start copying of a content and an instruction concerning the start position of the copying. An “instruction concerning the start position of the copying” is an instruction specifying the start position of the copying, such as whether the copying is to be started at the position that is currently under reproduction/playback or the copying is to be started from the beginning.

For example, after a message “Copy to DVD from position currently under reproduction/playback?” is displayed on the display section 16, the user is able to use a remote controller or the like to select and finalize “Yes”. The instruction receiving section 17 receives infrared radiated from the remote controller or the like, and notifies the selected and finalized instruction and an instruction concerning the start position of the copying to the control section 15, whereby the control section 15 can simultaneously receive a starting instruction to copy the content onto a DVD and an instruction that the copying is to be started from the position that is currently under reproduction/playback. As a result, based on the management information of the data stream, the control section 15 is able to search for and acquire a read position (address) in a data stream for specifying the position that is currently under reproduction/playback, which is necessary for starting the copy. The search for an address in the data stream may be performed by the control section 15, or by the first storage medium 10. It suffices so long as the control section 15 can acquire the address and give an instruction of the address to the first storage medium 10.

It is needless to say that, other than a currently-played back position of the content, the instruction receiving section 17 may receive an instruction that the copying is to be started from the beginning position of the content, for example. Moreover, the instruction receiving section 17 does not need to receive an instruction to start copying simultaneously with an instruction concerning the start position of the copying. The instruction receiving section 17 may first receive an instruction to start copying, and then receive information for selecting a content to be copied and an instruction concerning the start position of the copying.

Content Copying Process

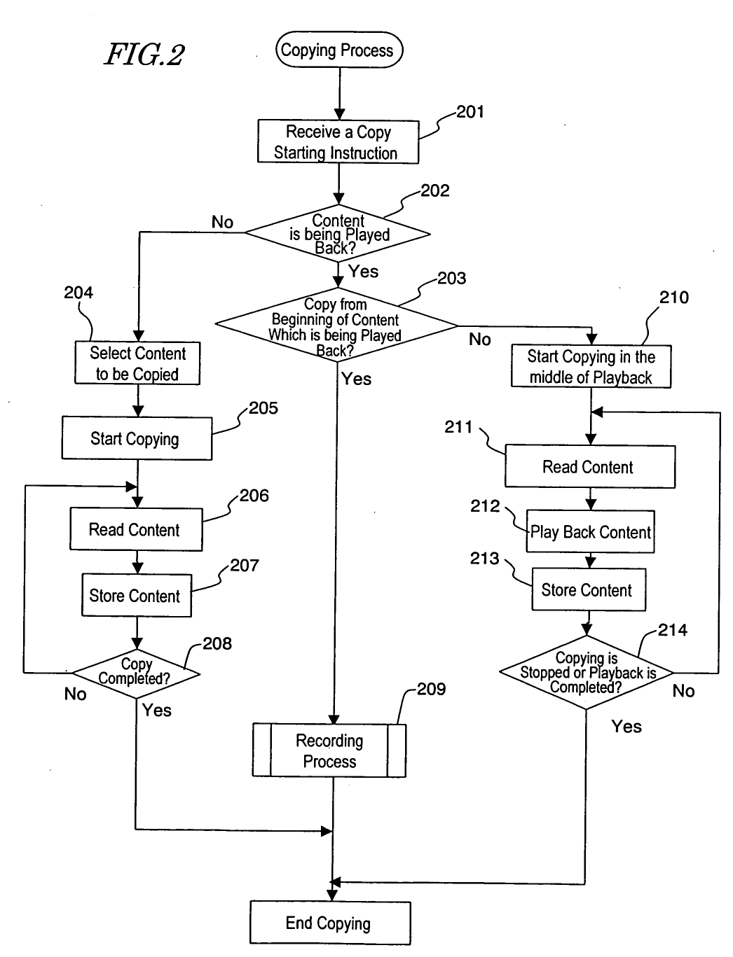

Next, with reference to FIG. 2, a content copying process by the content recording/playback apparatus 1 of FIG. 1 will be described. FIG. 2 is a flowchart showing the procedure of the content copying process. First, at step 201, when the instruction receiving section 17 receives a copy starting instruction from the user, the instruction is notified to the control section 15, and at step 202, the control section 15 determines whether the user is playing back a content or not. This determination is made based on, for example, whether or not the decoder 14 is currently outputting a decode content and the output is being transmitted by the control section 15 to the display section 16. If the user is playing back a content, control proceeds to step 203; if the user is not playing back a content, control proceeds to step 204.

First, if the user is not playing back a content, at step 204, the user selects a content to be copied from among contents A recorded on the first storage medium 10. Then, at step 205, the content recording/playback apparatus 1 starts copying. Specifically, at step 206, the control section 15 first gives an instruction to the first storage medium management section 12 so as to read a content to be copied, and at step 207, records onto the second storage medium 11 the content which has been read via the second storage medium management section 13. At step 208, the control section 15 determines whether or not copying of all or a designated range of the selected content has been finished. If it has not been finished, the process from step 206 is repeated until being finished; if it has been finished, the copying process is ended.

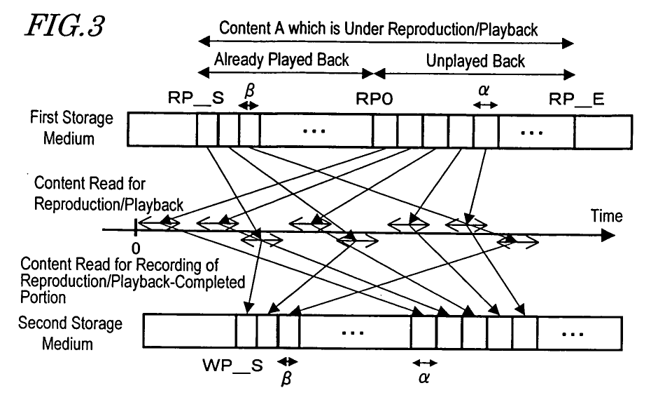

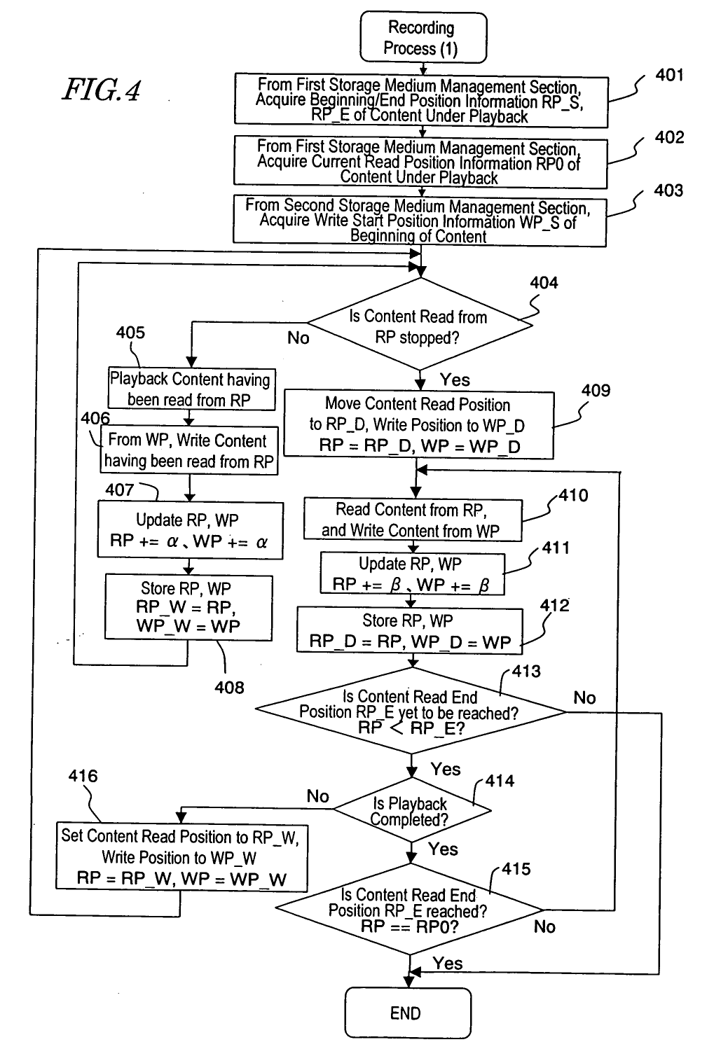

Next, if the user is playing back a content, the control section 15 displays on the display section 16 a message to inquire to the user as to whether to record from the beginning of the content A under reproduction/playback or from the position that is currently under reproduction/playback, and receives from the user an instruction to perform whichever copying. At step 203, the control section 15 determines whether or not it is an instruction to copy from the beginning of the content A which is being played back. If it is an instruction to copy from the beginning, the control section 15 performs a recording process at step 209; if it is any other instruction, the control section 15 performs the process from step 210. The recording process at step 209 is implemented as a so-called subroutine, as will be described later with reference to FIG. 3 and FIG. 4 in the present specification.

Step 210 means copying in the middle of playback. If the user inputs an instruction to record from the position that is currently under reproduction/playback by using an operation button, a remote controller, or the like, the instruction receiving section 17 receives this instruction and notifies it to the control section 15. Then, a copying process is started in the middle of playback. The control section 15 gives an instruction to the first storage medium management section 12 to read the content A on the first storage medium 10 from the current read position, and gives an instruction to the second storage medium management section 13 to record onto the second storage medium 11 the content having been read. At step 211, based on the instruction from the control section 15, the first storage medium management section 12 continues a read of the content A from the first storage medium 10 for playback. Then, the control section 15 and the display section 16 reproduce the decoded content by means of the decoder 14, and at step 212, the user continues playback. Concurrently with this process, at step 213, the control section 15 sends the encoded content having been read from the first storage medium management section 12 to the second storage medium management section 13, and the second storage medium management section 13 records this content onto the second storage medium 11. Then at step 214, an instruction to stop copying is received from the user, or it is determined whether the playback has been completed or not. Then, the process from step 211 is repeated until an instruction to stop copying is given or completion of playback. If an instruction to stop copying is given, or if playback is completed, the copying process is ended.

Next, with reference to FIG. 3 and FIG. 4, the recording process of step 209 will be described. While reproducing the content A recorded on the first storage medium 10, the content recording/playback apparatus 1 records this content onto the second storage medium 11. FIG. 3 is a diagram showing access timing when the content recording/playback apparatus of Embodiment 1 accesses a storage medium. In the present specification, for ease of understanding, it is assumed that the content A is recorded continuously from positions RP_S to RP_E on the first storage medium 10. It is assumed that playback of the content A has been finished with respect to the portion from positions RP_S to RP0 at the present time, and this point in time is defined as a reference time (0). Hereinafter, any portion of the content A whose reproduction/playback has been completed before the reference time will be referred to as an “already-played-back portion”, whereas any portion of the content A whose reproduction/playback is to be performed after the reference time will be referred to as an “unplayed-back portion”.

Hereinafter, descriptions will be given in chronological order. At time 0, a constant data amount α of unplayed-back portion is read from the position RP0 in the unplayed-back portion, and is processed for reproduction/playback and recorded onto the second storage medium 11. Then, another constant data amount α of unplayed-back portion is further read, and recorded onto the second storage medium 11.

Next, however, α constant data amount β of already-played-back portion is read from the position RP_S, and recorded onto the second storage medium 11. The meaning of this process is as follows. The reproduction/playback of the content A is performed in a series of actions, involving reading data from the first storage medium 10, decoding the data having been read, and displaying the decoded data as a reproduction image. A data read from the first storage medium 10 is not always being performed; rather, after a constant amount of data is read, no operation will occur until the next point of access timing. Therefore, this time of absence of operation (idle time) is utilized so that a read for recording an already-played-back portion is performed in the idle time. Note that write positions to the second storage medium 11 are to be determined so that continuity of the content will be obtained when all data has been written to the second storage medium 11. A more detailed description will be given later.

The aforementioned process will be described with reference to FIG. 1 and FIG. 4. FIG. 4 is a flowchart showing the flow of a process in which, while continuing a reproduction/playback of a content, the content is recorded onto the second storage medium 11.

At step 401, from the first storage medium management section 12, the control section 15 first acquires the beginning read position RP_S and the final read position RP_E of the content A recorded on the first storage medium 10. Furthermore, at step 402, the control section 15 acquires information of the read position RP0 of the content A at the start of recording. Next, at step 403, from the second storage medium management section, the control section 15 acquires information of a position WP_S on the second storage medium 11, from where writing of the content can be started. The control section 15 will retain all such acquired information.

Herein, the control section 15 derives an initial value of a content write position WP for the second storage medium 11 based on eq. (1).
WP=WP_{—}S+(RP0−RP_{—}S) (1)

The control section 15 notifies to the first storage medium management section 12 a read position RP of the content A for the first storage medium 10, and notifies to the second storage medium management section 13 a content write position WP for the second storage medium 11. The initial value of RP is RP0.

At step 404, the control section 15 determines whether the read of the content A from the current read position RP is currently stopped or not, i.e., whether now is idle time or not.

As is implied by the process of step 404, based on whether a read of the content A is being performed or not, appropriate switching is to be made between a process for the reproduction/playback of an unplayed-back portion of the content A and a process for the recording of an already-played-back portion at the start of recording. In particular, in the case where the content A is recorded in a variable-length encoded form, as in the encoding scheme under the MPEG-2 standard, the data amount per unit time will fluctuate. Therefore, it must be noted that a read of an unplayed-back portion for reproduction/playback and a read of an already-played-back portion for recording are not necessarily to be performed in alternating manners.

When switching between the process for the reproduction/playback of an unplayed-back portion and the process for the recording of an already-played-back portion, the control section 15 needs to switch the read position RP of the content A for the first storage medium 10 and the write position WP of the content A for the second storage medium 11. Concerning the unplayed-back portion, the read position on the first storage medium 10 and the write position on the second storage medium 11 are RP_W and WP_W, respectively. On the other hand, concerning the already-played-back portion, the read position on the first storage medium 10 and the write position on the second storage medium 11 are RP_D and WP_D, respectively. These positions are notified from the control section 15 to the first storage medium management section 12 and the second storage medium management section 13.

If step 404 finds that the read is not currently stopped, at step 405, the first storage medium management section 12 reads the content A from the current read position RP, decodes the content A having been read by means of the decoder 14, and plays back the content A by means of the display section 16. At step 406, the second storage medium management section 13 writes the content A having been read at step 405 to the second storage medium 11, sequentially from the write position WP. Next, at step 407, the read position RP and the write position WP are updated to new a read position and a write position as expressed by eq. (2) and (3) below.
RP←RP+α (2)
WP←WP+α (3)
In these equations, it is meant that the value of the right-hand side is to become an updated new value of the left-hand side. In the present specification, it is assumed that the meaning of “←” is the same in any of the following formulae. At step 408, the control section 15 stores the updated values of RP and WP, respectively as RP_W and WP_W. The above process is repeated until RP=RP_E, i.e., reproduction/playback is completed by reaching the end of the content A.

On the other hand, if step 404 finds that the reading from the content A from the read position RP is stopped, the control section 15 determines that it is idle time, i.e., no unplayed-back portion is being read from the first storage medium 10.

At the next step 409, the control section 15 notifies to the first storage medium management section 12 a read position RP of the content A for the first storage medium 10, and notifies to the second storage medium management section 13 a content write position WP for the second storage medium 11. The read position RP is a position RP_D on the first storage medium 10 at which an already-played-back portion exists. When first reading an already-played-back portion, it is set so that RP_D=RP_S. On the other hand, the write position WP is a position WP_D on the second storage medium 11 at which an already-played-back portion is recorded. When first writing an already-played-back portion, it is set so that WP_D=WP_S.

At step 410, when the first storage medium management section 12 has read the content A from the read position RP of the first storage medium 10, the second storage medium management section 13 records the content having been read to the write position WP of the second storage medium 11. At step 411, RP and WP are advanced by the data size β which has been read in one time, thus being updated as shown by eq. (4) and (5) below.
RP←RP+β (4)
WP←WP+β (5)
At step 412, the control section 15 stores the updated values of RP and WP, respectively as RP_D and WP_D.

Then, at step 413, based on the read position of the content A on the first storage medium 10, the control section 15 determines whether the read end position RP_E of the content A is yet to be reached. If it has been reached, the recording process is ended. If it has not been reached, control proceeds to step 414. Then at the next step 414, the control section 15 determines whether playback has been completed or not. If playback has been completed, control proceeds to step 415; if playback has not been completed, control proceeds to step 416. The process of step 415 means that playback is completed but copying of the content A may be uncompleted.

At step 415, the control section 15 determines whether the read position RP is RP0 or not. RP0 signifies the last position of the already-played-back portion at the start of the copying process. If the read position RP is RP0, the recording process is ended. If it is not RP0, the process from step 410 is repeated again. At step 416, the control section 15 sets the read position RP of the content A for the first storage medium 10 back to RP_W, and sets it as the read position of an unplayed-back portion. At the same time, the control section 15 sets the content write position WP for the second storage medium 11 back to WP_W, and sets it as the write position of an unplayed-back portion.

Thus, a process of recording a content to the second storage medium 11 is performed. A write start position for the second storage medium 11 is determined based on eq. (1), and therefore, at the end of the copying, the content will have been recorded in the order in which it has been reproduced.

In the above-described recording process, the process for reproduction/playback of unplayed-back portions of the content A is preferably executed with a higher priority over the process for recording of the already-played-back portion at the start of recording. The reason is that the process for reproduction/playback of unplayed-back portions requires more of real time ability. When performing the process for reproduction/playback of unplayed-back portions with a higher priority, it may become necessary to perform a read from the first storage medium 10 for reproduction/playback, even before completing a read of the already-played-back portion from the first storage medium 10 or a write to the second storage medium 11 for recording of the already-played-back portion. Or, even before completing a write of the already-played-back portion to the second storage medium 11, it may become necessary to perform a write to the second storage medium 11 for reproduction/playback. In such cases, the first storage medium management section 12 or the second storage medium management section 13 notifies so to the control section 15. Upon these notifications, the control section 15 interrupts the series of operations, and again executes such processes after completing the process for reproduction/playback.

Hereinafter, based on more specific conditions, conditions when performing a read for the already-played-back portion by utilizing idle time between read processes of unplayed-back portions will be discussed. It is assumed that the first storage medium 10 on which a content A is recorded is a hard disk and that the second storage medium 11 is a rewritable-type DVD. As the hard disk, a product of U.S. Seagate Technology, designated Barracuda 7200.7, is adopted. The performance of this hard disk is as follows.

Size of data to be read in one time: 128 kbytes

Maximum transfer rate: 85.37 Mbps

Sustained transfer rate: 32 to 58 Mbps (about 40 Mbps on average)

Maximum seek time: 25 msec

Average seek time: 8.5 msec

Revolution: 7200 rpm

Average rotation waiting time: 4.16 msec

Hereinafter, a waiting time when dubbing (copying) a content A from a hard disk having the aforementioned performance to a DVD will be discussed. For example, the bit rate of a HD (High Definition) broadcast used for BS digital broadcasts and the like is 28.8 Mbps, and this HD broadcast will be considered as a content to be played back.

Firstly, in order to secure 28.8 Mbits per second, it is necessary to read 128 kbytes (=1024 kbits) of data from the hard disk within 35.56 msec. On the other hand, the time required for reading 128 kbytes of data from a hard disk at one time is 15.94 msec on average. Thus, the waiting time until a next read will be about 19.6 msec, so that it would be possible to again read at least 128 kbytes of data. Accordingly, if this waiting time is utilized to read an already-played-back portion for recording, it will be sufficiently possible to read an already-played-back portion for recording, during the idle time after an unplayed-back portion for reproduction/playback is read. Since the unplayed-back portion for reproduction/playback is to be read from continuous regions, the seek time will be reduced. Therefore, in practice, the read process will satisfy the aforementioned requirements in most cases.

In particular, the above example uses a high bit-rate stream, e.g., HD broadcast. From the standpoint of copying onto a DVD, in practice, it is likely to deal with a data stream of SD (Standard Definition) broadcast, having a bit rate on the order of 9 to 10 Mbps, which is used for analog terrestrial waves and the like. In the case of an SD broadcast data stream, the idle time in data read from the hard disk will be about 86.5 msec, i.e., several times as much. Therefore, in the case of an SD broadcast, in practice, it will be possible to sufficiently cope with a situation where the worst cases (where a read requires 37.42 msec) continue.

Next, a process in the case where a user newly inputs an instruction will be described. The content recording/playback apparatus 1 is equipped with a process of, upon receiving an instruction from a user, forcibly executing the instruction irrespective of its processing situation. Hereinafter, an instruction from the user will be referred to as an “interrupting instruction”, and a process which is executed based on an interrupting instruction will be referred to as an “interruption process”. Three types of interruption processes will be described below.

Interruption Process (1)

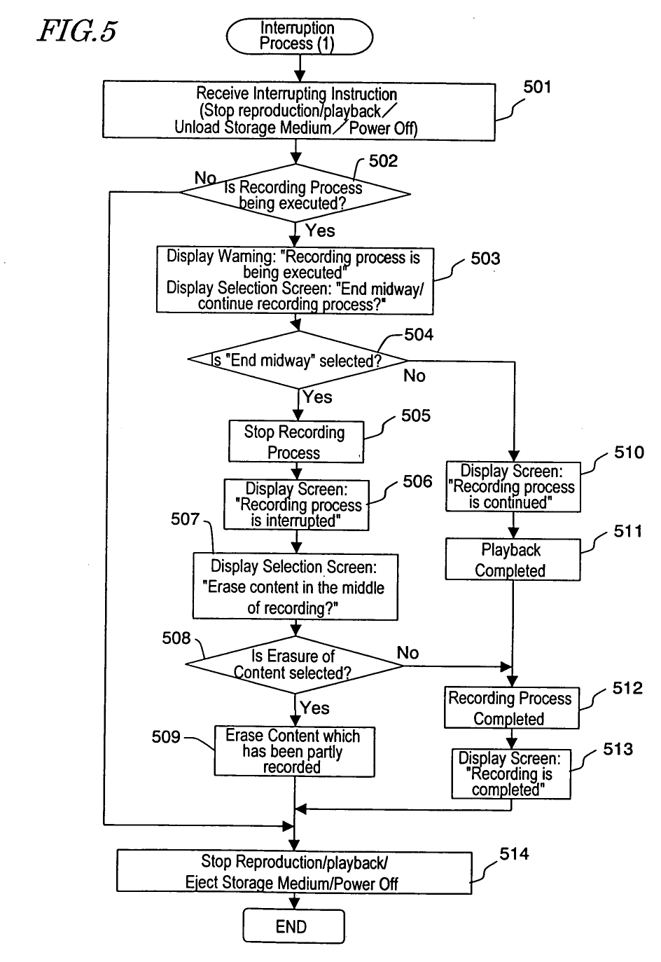

FIG. 5 is a flowchart showing the flow of a first interruption process when receiving an interrupting instruction. The first interruption process is executed when an instruction to stop reproduction/playback, power off, or unload a storage medium is given as an interrupting instruction.

First, at step 501, if the control section 15 receives the aforementioned interrupting instruction from the user, an interruption process is started. At step 502, the control section 15 determines whether a recording process is being currently performed or not. If no recording process is being performed, control proceeds to step 514, and at step 514, powering off or ejection of a storage medium is performed right ahead, unless a content A recorded on the first storage medium is under reproduction/playback. If the content A is under reproduction/playback, the reproduction/playback is ended, and then powering off or ejection of a storage medium is performed. Thereafter, this interruption process is ended.

If a recording process is being performed, control proceeds to step 503. At step 503, the control section 15 displays on the display section 16 that a recording process is being executed, and further displays a message indicating whether the recording process is to be continued or ended in the middle of the recording. Based on this display, the user further inputs an instruction.

At step 504, if the user selects ending midway and the instruction receiving section 17 receives an instruction of this selection, control proceeds to step 505. If the user does not select ending midway, control proceeds to step 510.

At step 505, the control section 15 stops the recording process, and at step 506, displays on the display section 16 that the recording process is interrupted. Then, at step 507, the control section 15 displays on the display section a message for permitting selection as to whether or not to erase the content which is in the middle of recording. At step 508, if the user selects to erase the content which is in the middle of recording, control proceeds to step 509. At step 509, the content which is in the middle of recording is erased, and stopping reproduction/playback, powering off, or ejection of the storage medium at step 514 is performed. If it is not selected to erase the content which is in the middle of recording, control proceeds to step 512. At step 512, the control section 15 ends the recording process, and at step 513, displays on the display section 16 a message indicating completion of recording, i.e., that recording is completed as for the content which has been recorded up to the present time. Thereafter, at step 514, stopping reproduction/playback, powering off, or ejection of the storage medium is performed.

On the other hand, at step 510, the control section 15 outputs to the display section 16 a message that a recording process is to be continued, and ends reproduction/playback at step 511. Then, at step S512 described above, the content A is recorded down to the end, and, upon completion of the recording, control proceeds to step 513 and a message of that indication is displayed on the display section.

Interruption Process (2)

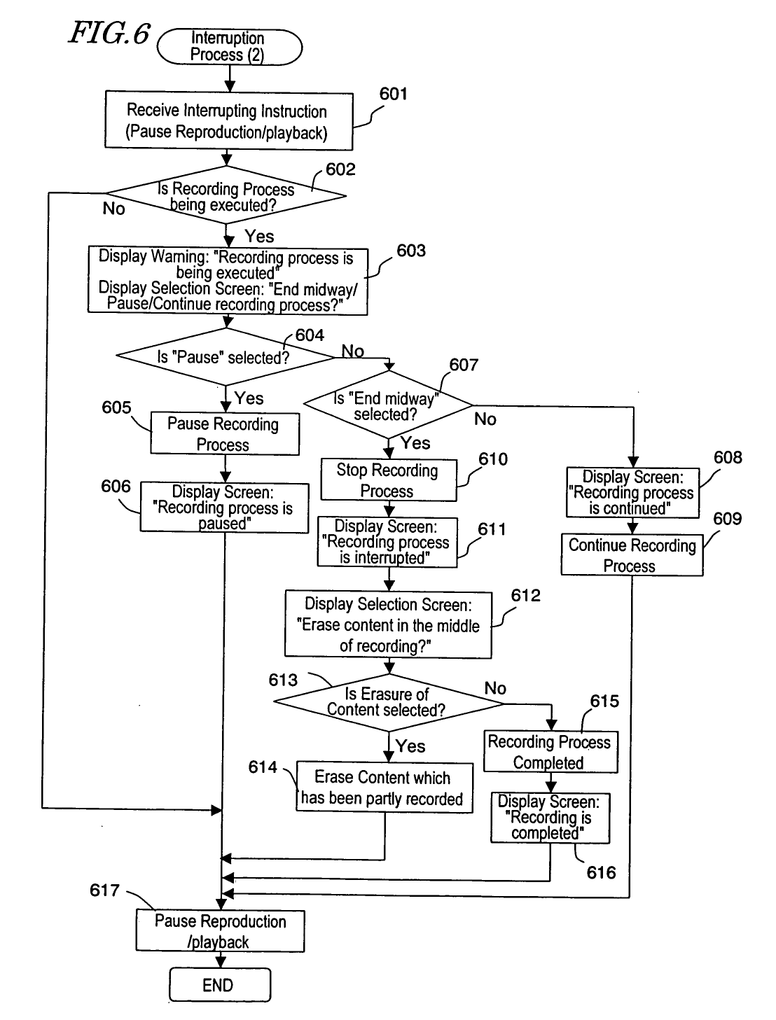

FIG. 6 is a flowchart showing the flow of a second interruption process when receiving an interrupting instruction. The second interruption process is executed when an instruction to pause reproduction/playback during recording is given as an interrupting instruction.

First, at step 601, if the control section 15 receives an interrupting instruction concerning pausing of reproduction/playback from the user, an interruption process is started. At step 602, the control section 15 determines whether a recording process is being performed or not. If no recording process is being performed, control proceeds to step 617. Then at step 617, if it is not during reproduction/playback of a content A recorded on the first storage medium, that state is retained. If it is during reproduction/playback of the content A, reproduction/playback is paused.

If a recording process is being performed, control proceeds to step 603. At step 603, the control section 15 displays on the display section 16 a message that a recording process is being performed, and further displays a message indicating whether the recording process is to be ended midway, placed in a paused state, or continued. Based on this display, the user further inputs an instruction.

At step 604, if the user inputs an instruction to pause the recording process and the instruction receiving section 17 receives an instruction of this selection, control proceeds to step 605. If an instruction to pause is not input, control proceeds to step 607.

At step 605, the control section 15 pauses the recording process. At step 606, pausing of the recording process is displayed on the display section 16. At step 617, reproduction/playback is placed in a paused state.

On the other hand, the processes of step 607 and steps 610 to 614 are the same as the processes from steps 504 to 509 in FIG. 5. Therefore, the descriptions thereof are omitted. At step 615, the recording process is completed at that point. Any hitherto-written data of the content will be retained intact. At step 616, the display section displays a message indicating completion of recording. Then at step 617, reproduction/playback is stopped.

If the determination of step 607 finds that the recording process is to be continued based on the user's instruction, a message that the recording process is to be continued is output to the display section 16 at step 608, and the recording process is continued as it is at step 609. Thereafter, control proceeds to step 617, and reproduction/playback is stopped. However, the recording process is continued as it is. In this case, since the read of the content A for reproduction/playback is being stopped, the already-played-back portion for which reproduction/playback had already been completed at the start of the recording process is recorded onto the second storage medium 11, and when this recording is completed, an unplayed-back portion is next recorded.

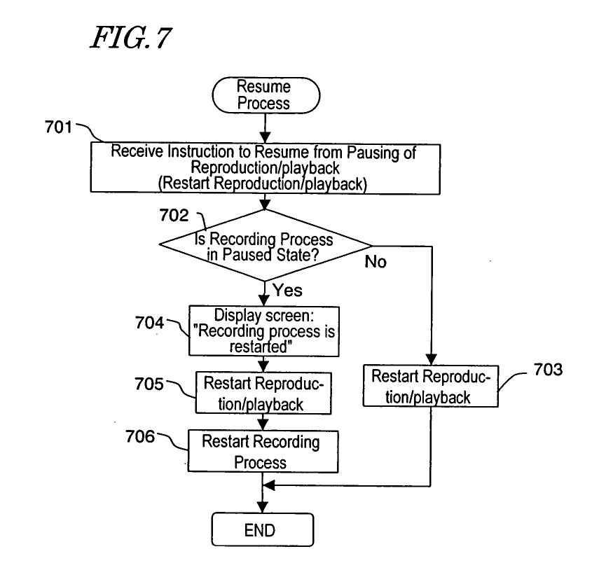

Next, referring to FIG. 7, a resume process from the reproduction/playback paused state at step 617 of FIG. 6 will be described. FIG. 7 is a flowchart showing the flow of a resume process from a reproduction/playback paused state. At step 701, if a notification is given from the instruction receiving section 17 that the control section 15 has received from the user an instruction to restart reproduction/playback (resuming instruction), the control section 15 determines at step 702 whether the recording process is in a paused state or not. If it is not in a paused state, control proceeds to step 703. If it is in a paused state, control proceeds to step 704. At step 703, the control section 15 only restarts reproduction/playback. On the other hand, at step 704, the control section 15 displays on the display section 16 a notification that the recording process is restarted, starts reproduction/playback, and also starts a recording process at step 706.

Interruption Process (3)

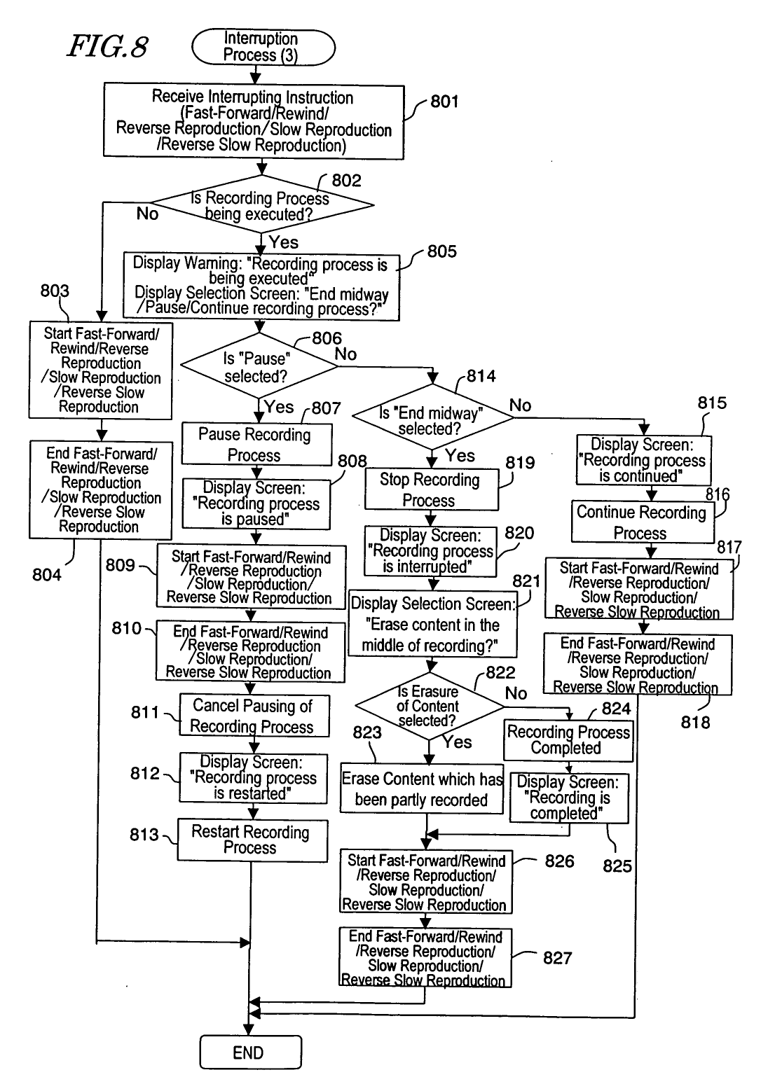

FIG. 8 is a flowchart showing the flow of a third interruption process when receiving an interrupting instruction. The third interruption process is executed when an instruction of fast-forward or rewind of reproduction/playback, reverse reproduction, slow reproduction, or reverse slow reproduction is given as an interrupting instruction during recording.

First, at step 801, if the control section 15 receives the aforementioned interrupting instruction from the user, an interruption process is started. Then at step 802, the control section 15 determines whether a recording process is being currently performed or not. If no recording process is being performed, control proceeds to step 803. If a recording process is being performed, control proceeds to step 805. At step 803, if it is during reproduction/playback of a content A, a process based on that instruction is executed. Then, if an instruction to stop or the like is received, or if a process has been performed for a predetermined time, that process is stopped at step 804, and the interruption process is ended.

On the other hand, at step 805, the control section 15 displays a message on the display section 16 that a recording process is being performed, and further displays a message as to whether the recording process is to be ended midway, placed in a paused state, or the recording process is to be continued. Based on this display, the user further inputs an instruction.

At step 806, if a notification is given from the instruction receiving section 17 that the control section 15 has received from the user an instruction to pause the recording process, control proceeds to step 807. If the instruction receiving section 17 receives any instruction other than this instruction, control proceeds to step 814.

At step 807, the control section 15 pauses the recording process, and displays that indication on the display section 16 at step 808. Thereafter at steps 809 and 810, the control section 15 performs the same processes as those described with respect to steps 803 and 804 above, and after their completion, control proceeds to step 811. At step 811, the control section 15 cancels pausing of the recording process, and at step 812 displays a message of that indication on the display section 16, and at step 813, restarts a recording process. Thereafter, the interruption process is ended.

At step 814, if the user selects ending midway and the instruction receiving section 17 receives an instruction of this selection, control proceeds to step 819. If the user does not select ending midway, control proceeds to step 815.

At step 819, the control section 15 stops the recording process, and at step 820, displays via the display section 16 a message that the recording process is interrupted. Thereafter at step 821, the control section 15 displays via the display section 16 a message indicating whether or not to erase the content which is in the middle of recording, and control proceeds to step 822. At step 822, if the user selects to erase the content and that instruction is notified to the control section 15 via the instruction receiving section 17, control proceeds to step 823. If the user does not select to erase the content, control proceeds to step 824. At step 823, the control section 15 gives an instruction to the second storage medium management section 13 to erase the content which has been partly recorded. At step 824, the control section 15 ends the recording process, and at step 825, a message indicating completion of recording, i.e., that recording is completed as for the portion which has been recorded up to the present time. Thereafter, at steps 826 and 827, the control section 15 performs the same processes as those described with respect to steps 803 and 804 above. Thereafter, the interruption process is ended.

At step 815, the control section 15 displays via the display section 16 a message that the recording process is to be continued, and at step 816 continues the recording process. Thereafter, independently of the recording process, at steps 817 and 818, an operation which is in accordance with the instruction received at the instruction receiving section 17 is performed. In this case, it is possible that the content A which is read for reproduction/playback after completion of the operation may overlap with the hitherto-recorded content; in that case, it may be overwritten with the same data, or recording thereof may be omitted.

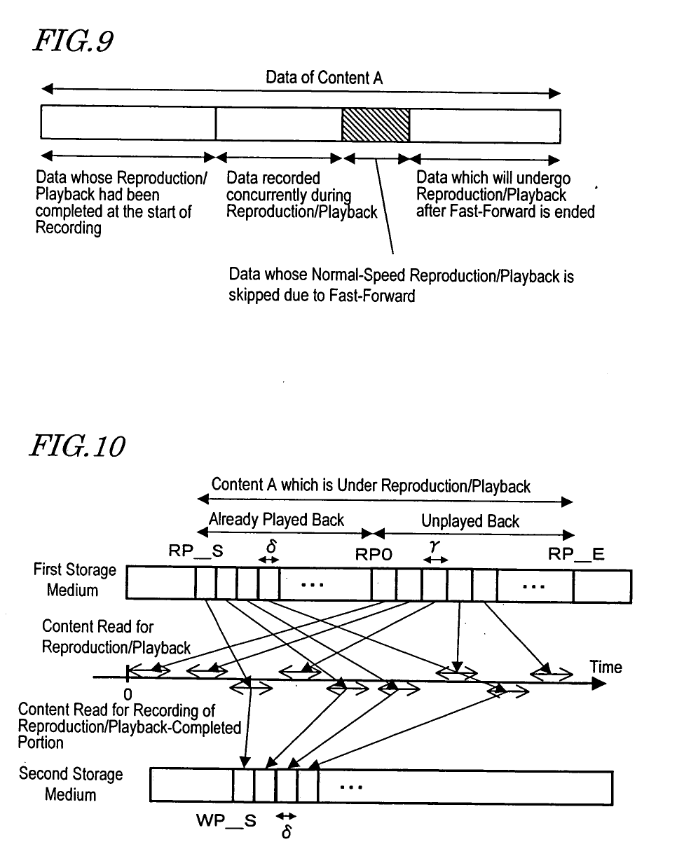

For example, the process of step 817 described above is executed in a period during which reproduction/playback of a content A recorded on the first storage medium 10 is under way and also a process of recording the content A onto the second storage medium is being performed. If the interrupting instruction from the user is a process of fast-forward reproduction, there exists data whose normal-speed reproduction/playback is to be skipped. FIG. 9 is a diagram showing data whose normal-speed reproduction/playback is skipped due to fast-forward. During fast-forward reproduction, since reproduction is performed by using less data than data necessary for normal-speed reproduction, there is data which is not utilized for reproduction. Therefore, as for the skipped portions, after recording of the already-reproduced data at the start of recording is completed, they are read from the first storage medium 10, and recorded onto the second storage medium 11. For this purpose, the control section 15 retains information concerning the start and end positions at which reproduction/playback was skipped.

The above-described processes are to be performed in the case where a content that is read for reproduction/playback is also concurrently recorded during playback. In any other cases, a read of the content A for reproduction/playback and a read of the content A for recording are completely independent, and therefore when special operations such as those described above are given, no special determinations are required; any instruction received at the instruction receiving section 17 may just be executed.

Note that, even while any of the interruption processes (1) to (3) is being executed, a still another interruption process may be performed. For example, when the interruption process (3) is being executed, if an interrupting instruction concerning unloading of the storage medium is input, then the interruption process (1) will be executed. Moreover, each of the interruption processes (1) to (3) described above can also be executed during the processes of the content recording/playback apparatuses according to Embodiments 2 to 4 described below.

Thus, the content recording/playback apparatus 1 according to Embodiment 1 has been described. As described above, while giving priority to the reproduction/playback of the content A recorded on the first storage medium 10, the control section 15 of the content recording/playback apparatus 1 reads, in periods during which unplayed-back portions of the content A are not read, an already-played-back portion at the point when a recording starting instruction for the content A is issued. As a result, while continuing the reproduction/playback of the content A, the content A under reproduction can be copied onto the second storage medium. Since the already-played-back portion is concurrently recorded in the meantime of recording the content A for reproduction/playback, the waiting time after the end of playback and until completion of recording can be reduced.

Moreover, although it is assumed in Embodiment 1 that the data size which is read for reproduction/playback of the content A is a and the data size which is read for recording of the content A is β, these values may be fixed or variable. For example, in the case where the content is encoded by a variable-length encoding scheme as in the MPEG-2 standard, the data size to be read at one time may greatly fluctuate depending on the scene of the content that is under reproduction/playback. In such cases, the aforementioned α and β are therefore variable.

### Embodiment 2

It is assumed that the content recording/playback apparatus 1 of Embodiment 1 reads an already-played-back portion of a content A and writes it to the second storage medium 11 in a period during which a read from the first storage medium 10 of an unplayed-back portion for reproduction/playback is not being performed.

A content recording/playback apparatus according to the present embodiment has the same structure as that of the content recording/playback apparatus 1 of FIG. 1, and performs a different process from that of the content recording/playback apparatus 1 of Embodiment 1. Specifically, the content recording/playback apparatus reads data from the beginning of a content A and records it onto the second storage medium 11, in a period during which a read from the first storage medium 10 of an unplayed-back portion for reproduction/playback is not being performed. The data having been read for reproduction/playback is utilized only for the sake of reproduction/playback, and its recording onto the second storage medium 11 will be later performed by being read out again. Note that, in the present embodiment, the compression/encoding schemes for the contents recorded on the first storage medium 10 and on the second storage medium 11 are identical.

FIG. 10 is a diagram showing access timing when a content recording/playback apparatus of the present embodiment accesses a storage medium. While reproducing a content A recorded on the first storage medium 10, the content recording/playback apparatus records the content A onto the second storage medium 11.

Hereinafter, descriptions will be given in chronological order. At time 0, a constant data amount γ of unplayed-back portion is read from the position RP0 in the unplayed-back portion, and is utilized for playback/reproduction. The data of this unplayed-back portion is not recorded onto the second storage medium 11, but will later be read from the first storage medium 10 again and recorded onto the second storage medium 11. Since the content recording/playback apparatus 1 of Embodiment 1 would record the unplayed-back portion onto the second storage medium 11 right ahead, the content recording/playback apparatus 1 of the present embodiment differs from the content recording/playback apparatus of Embodiment 1 in this respect. Then, another constant data amount γ of unplayed-back portion is further read, and subjected to playback/reproduction. This data is also not recorded onto the second storage medium 11 right ahead. Next, a constant data amount δ of already-played-back portion is read from the position RP_S, and recorded onto the second storage medium 11. The read of the already-played-back portion is to be performed by utilizing the idle time after a constant data amount γ of unplayed-back portion is read and before the next point of access timing. The data having been read is recorded onto a position WP_S on the second storage medium 11. Thereafter, during the idle time after a read of an unplayed-back portion, the control section 15 will read out from the first storage medium 10 and record onto the second storage medium 11, sequentially from the already-played-back portion at the beginning of the content A. As a result, the content A is copied to the second storage medium 11.

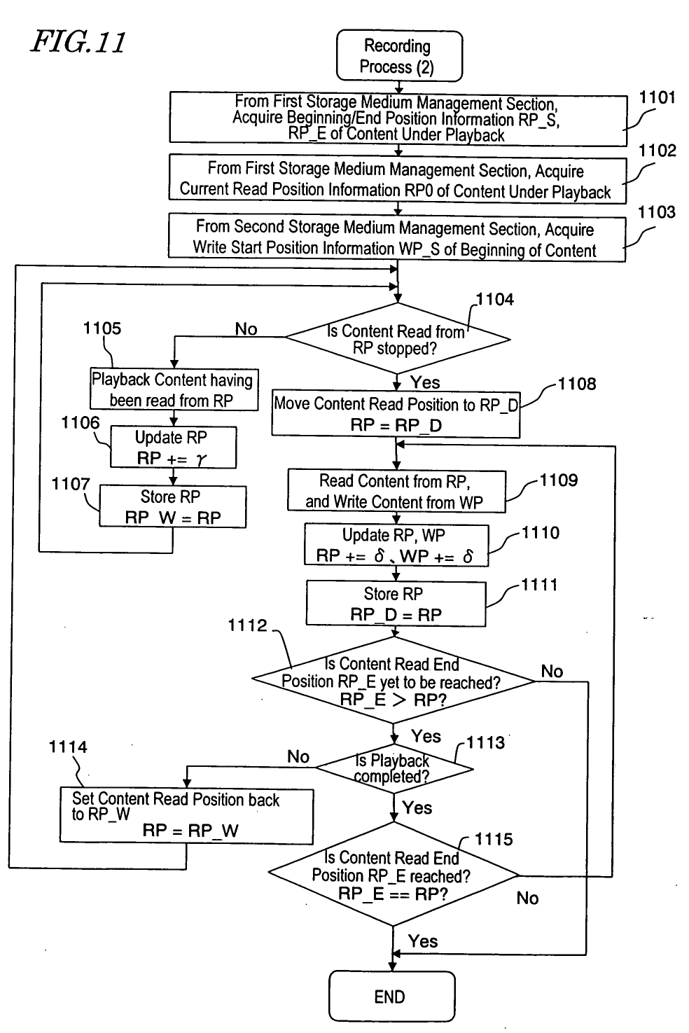

The aforementioned process will be described with reference to FIG. 1 and FIG. 11. FIG. 11 is a flowchart showing the flow of a recording process of the content recording/playback apparatus of Embodiment 2. While continuing reproduction/playback of a content A, the content recording/playback apparatus records the content A onto the second storage medium 11. This process is a process to be executed at step 209 in FIG. 2, and can be executed in the place of the recording process of FIG. 4.

Steps 1101 to 1104 are identical to steps 401 to 403 in FIG. 4, and the descriptions thereof are omitted. Through the processes of steps 1101 to 1104, the control section 15 acquires information of the beginning read position RP_S and final read position RP_E of the content A recorded on the first storage medium 10, a read position RP0 of the content A at the start of recording, and a content-writable beginning position WP_S on the second storage medium 11.

At step 1105, if an unplayed-back portion is being read from the first storage medium 10 for reproduction/playback, the control section 15 notifies to the first storage medium management section 12 a read position RP of the content A for the first storage medium 10; the decoder 14 decodes the content A having been read, from the read position RP on the first storage medium 10; and the display section 16 displays the decoded content A, thus performing reproduction/playback. Given that the initial value of RP is RP0, at the next step 1106, RP is advanced by the data size γ which has been read in one time, thus being updated as shown by eq. (6).
RP←RP+γ (6)
At step 1107, the control section 15 stores the updated value of RP, as RP_W.

On the other hand, if a read of the content A from the read position RP is being stopped at step 1104, the control section 15 determines that it is idle time, i.e., no unplayed-back portion is being read from the first storage medium 10, and control proceeds to step 1108.

At step 1108, the control section 15 notifies to the first storage medium management section 12 a read position RP of the content A for the first storage medium 10, and notifies to the second storage medium management section 13 a write position WP of the content A for the second storage medium 11. It is assumed that the initial values of RP and WP are RP_S and WP_S, respectively. At step 1109, the content A is read from the read position RP on the first storage medium 10, and the content A having been read is recorded at the write position WP on the second storage medium 11. At step 1110, RP and WP are advanced by the data size δ which has been read in one time, thus being updated as shown by eq. (7) and (8) below.
RP←RP+δ (7)
WP←WP+δ (8)
At step 1111, the control section 15 stores the update value of RP, as RP_D.

Then, at step 1112, based on the read position of the content A on the first storage medium 10, the control section 15 determines whether the read end position RP_E of the content A is yet to be reached. If it has been reached, the recording process is ended. If it has not been reached, control proceeds to step 1113. Then at the next step 1113, the control section 15 determines whether playback has been completed or not. If playback has been completed, control proceeds to step 1115; if playback has not been completed, control proceeds to step 1114. The process of step 1115 means that playback is completed but copying of the content A may be uncompleted. At step 1115, the control section 15 determines whether the read position RP is the last position RP_E of the content A or not. If the read position RP is RP_E, the recording process is ended. If it is not RP_E, the process from step 1109 is repeated again. At step 1114, the control section 15 sets the read position RP of the content A for the first storage medium 10 back to RP_W, and sets it as the read position of an unplayed-back portion.

As described above, a process of recording the content A onto the second storage medium 11 is performed.

The above-described step 1104 makes a determination of switching between a process for reproduction/playback of the content A and a process for recording of the playback-completed portion at the start of recording. Based on this determination, also in the present embodiment, the aforementioned two processes are switched to either one as appropriate, rather than in alternating manners. When switching between the processes, the control section 15 sets the read position RP of the content A for the first storage medium 10 to either RP_W or RP_D, and notifies it to the first storage medium management section 12. Note that, between the two processes, priority is given to the reproduction/playback of the content A, which requires real time ability. Therefore, in the case where a need to perform a read of the content A for reproduction/playback arises prior to the completion of a read of the content A from the read position RP on the first storage medium 10 for recording the playback-completed portion at the start of recording, the first storage medium management section 12 notifies that indication to the control section 15 and interrupts the series of operations, and again executes a similar process after the read for reproduction/playback is completed.

In accordance with the content recording/playback apparatus of the present embodiment, the content A can be recorded onto the second storage medium 11 while maintaining reproduction/playback of the content A which is recorded on the first storage medium 10. While giving priority to the reproduction/playback of the content A which is recorded on the first storage medium 10, the content recording/playback apparatus 1 utilizes, for the sake of reading the content A, any period during which a data read of the content A for reproduction/playback is not performed. The content A is sequentially read from the beginning, and recorded onto the second storage medium 11. Thus, while maintaining reproduction/playback of the content A, the content A can be recorded onto the second storage medium 11, such that data other than the data of the portion which is undergoing reproduction/playback can be recorded concurrently with the reproduction/playback. Since data recording is performed during the playback, the waiting time after the end of playback and until completion of recording can be reduced. Especially in the case where the speed of data read from the first storage medium 10 and the speed of data write to the second storage medium 11 are sufficiently fast, it is even possible to complete the recording of the content A onto the second storage medium 11 while the content A is undergoing reproduction/playback.

As is the case with Embodiment 1 described above, although it is assumed in Embodiment 2 that the data size which is read for reproduction/playback of the content A from the first storage medium 10 is γ and the data size which is read for recording of the content A is δ, these values may be fixed or variable. Moreover, these values may be equal.

### Embodiment 3

In the content recording/playback apparatuses of Embodiments 1 and 2, a content A recorded on the first storage medium 10 is read and recorded onto the second storage medium 11 in a period during which a read of the content A from the first storage medium 10 is not performed.

A content recording/playback apparatus according to the present embodiment has the same structure as that of the content recording/playback apparatus 1 of FIG. 1, and performs a different process from those of the content recording/playback apparatuses of Embodiments 1 and 2. Specifically, while reading data of a content A which is recorded on the first storage medium 1 and utilizing it for reproduction/playback, the content recording/playback apparatus also records it onto the second storage medium 11. During any period in which a read of the data is not performed, a read of any other data is also not performed. After the reproduction/playback of the content A is ended, the content A is read from its beginning portion, so as to be recorded onto the second storage medium 11. Note that, in the present embodiment, the compression/encoding schemes for the contents recorded on the first storage medium 10 and on the second storage medium 11 are identical.

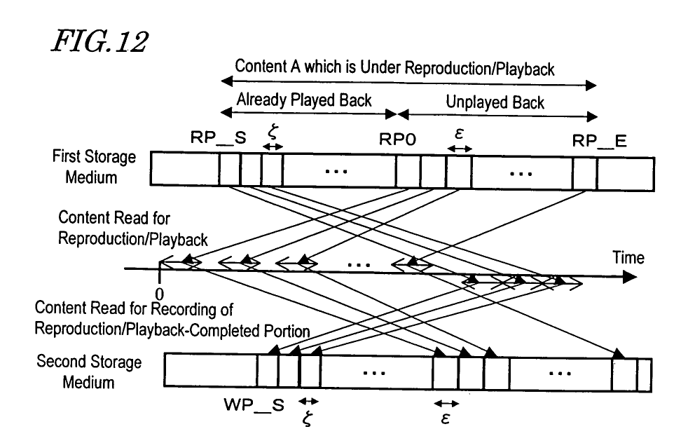

FIG. 12 is a diagram showing access timing when a content recording/playback apparatus of the present embodiment accesses a storage medium.

Hereinafter, descriptions will be given in chronological order. At time 0, a constant data amount ε of unplayed-back portion is read from the position RP0 in the unplayed-back portion and processed for reproduction/playback, and also the data having been read is recorded onto the second storage medium 11. Thereafter, every constant data amount ε of unplayed-back portion is read from the storage medium 10 and recorded onto the second storage medium 11. This process is continuously performed down to the end of the content A. Once the last position RP_E of the content A is reached, a read is performed from the beginning position RP_S of the content A by every constant data amount ζ, so as to be recorded to the position WP_S and later positions of the second storage medium 11. The control section 15 continues this process up to the data position RP0 which was undergoing reproduction/playback at the point when a recording starting instruction of the content A was issued. As a result, the content A is copied onto the second storage medium 11.

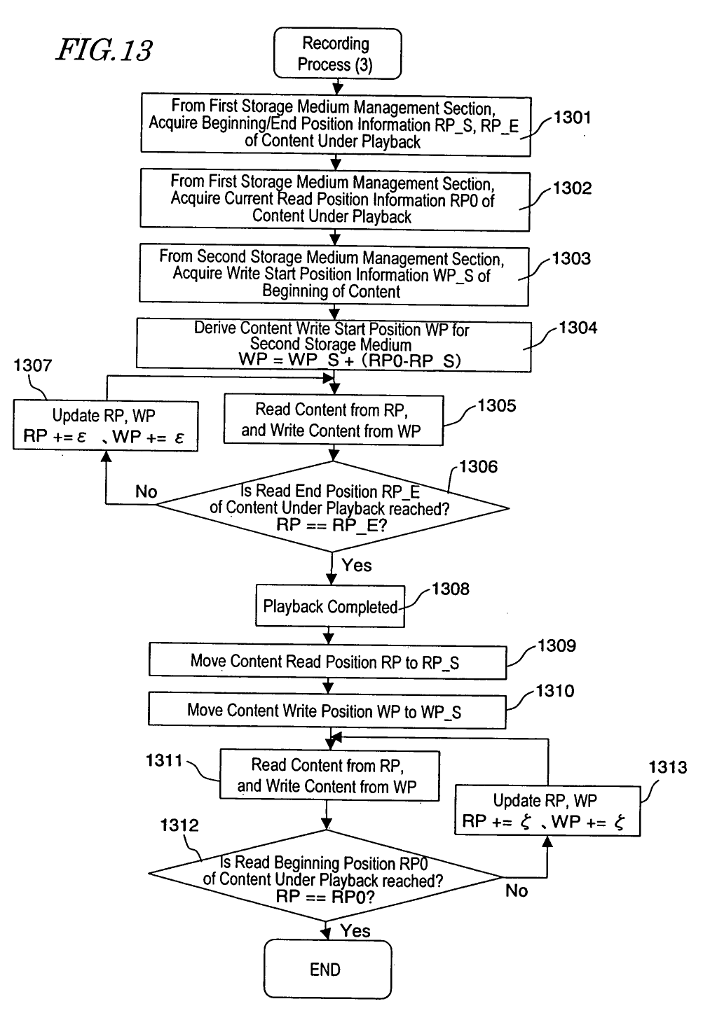

The aforementioned process will be described with reference to FIG. 1 and FIG. 13. FIG. 13 is a flowchart showing the flow of a recording process of the content recording/playback apparatus of Embodiment 3. This process is a process to be executed at step 209 in FIG. 2, and can be executed in the place of the recording process of FIG. 4.

Firstly, steps 1301 to 1303 are identical to steps 401 to 403 in FIG. 4, and the descriptions thereof are omitted. Through these processes, the control section 15 acquires information of the beginning read position RP_S and final read position RP_E of the content A recorded on the first storage medium 10, a read position RP0 of the content A at the start of recording, and a content-writable beginning position WP_S on the second storage medium 11.

At step 1304, the control section 15 derives an initial value of a content write position WP for the second storage medium 11 based on eq. (9) below.
WP=WP_{—}S+(RP0−RP_{—}S) (9)

The control section 15 notifies a content write position WP for the second storage medium 11 to the second storage medium management section 13. At step 1305, the control section 15 reads the content A from a current read position RP on the first storage medium 10, decodes the content A having been read by means of the decoder 14, and subjects it to reproduction/playback by the display section 16. Furthermore, the content A having been read is recorded to the write position WP and later positions on the second storage medium 11. At step 1306, the control section 15 determines whether the current read position RP has reached the read end position RP_E or not. If it has not been reached, control proceeds to step 1307. If it has been reached, control proceeds to step 1308. At step 1307, the control section 15 advances the current read position RP and the current write position WP by the data size ε which has been read in one time for reproduction/playback. In other words, the control section 15 updates the current read position RP and the current write position WP as shown by eq. (10) and (11) below.
RP←RP+ε (10)
WP←WP+ε (11)
After this process, control returns to step 1305.

Step 1308 means completion of reproduction/playback of the content A. When reproduction/playback of the content A is completed, the first storage medium management section 12 notifies that indication to the control section 15. At step 1309 and step 1310, respectively, the control section 15 having received the notification moves the read position RP from the first storage medium 10 to RP_S, and the write position WP to the second storage medium 11 to WP_S. The control section 15 notifies the updated RP to the first storage medium management section 12 and the updated WP to the second storage medium management section 13. At step 1311, the control section 15 reads the content A from the read position RP on the first storage medium 10, and records the content A having been read to the write position WP and later positions on the second storage medium 11. At step 1312, the control section 15 determines whether or not the current read position RP has reached the position RP0 at which reading was started. If it has not been reached, control proceeds to step 1313. If it has been reached, the process is ended.

At step 1313, RP and WP are advanced by the data size ζ which has been read in one time, thus being updated as shown by eq. (12) and (13) below.
RP←RP+ζ (12)
WP←WP+ζ (13)
After this process, control returns to step 1311.

Thus, a process of recording the content A onto the second storage medium 11 is performed.

The content recording/playback apparatus of the present embodiment is able to, while maintaining reproduction/playback of a content A recorded on the first storage medium 10, record the content A onto the second storage medium 11. While utilizing the content A recorded on the first storage medium 10 for the sake of reproduction/playback, the content recording/playback apparatus 1 also concurrently records it onto the second storage medium 11. Then, after reproduction/playback of the content A is completed, the control section 15 reads from the first storage medium 10 the already-played-back portion which had already been played back at the start of recording, and records it onto the second storage medium 11. Thus, even in the case of a content recording/playback apparatus whose reading performance from a storage medium and whose writing performance to a storage medium are low, the waiting time from completion of reproduction/playback of the content A until completion of recording can be reduced.

### Embodiment 4

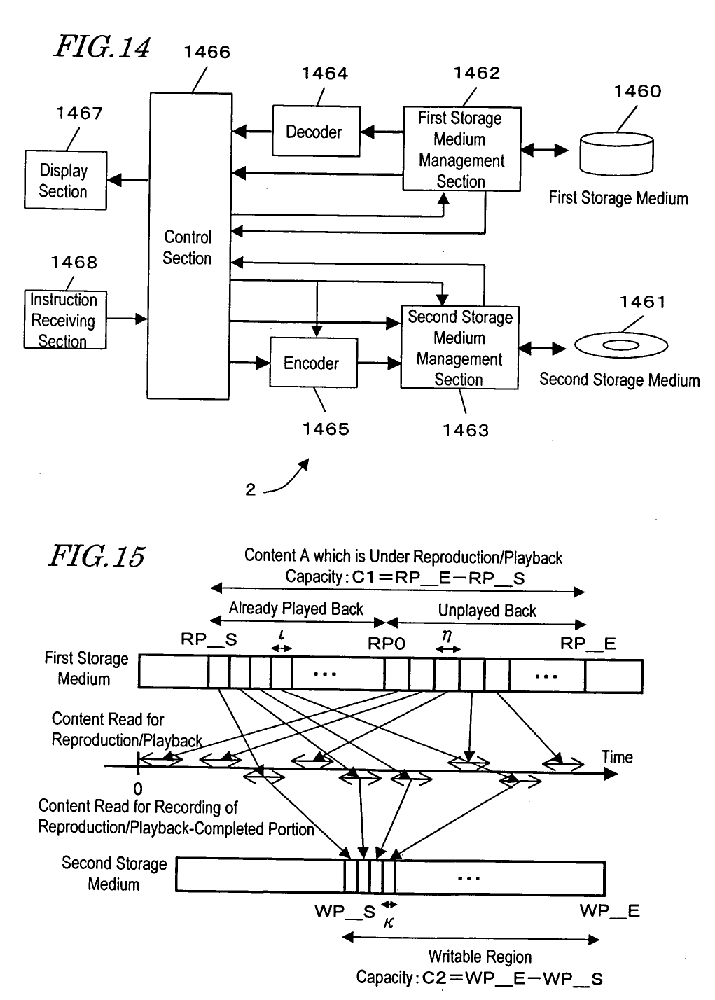

FIG. 14 is a block diagram showing the structure of a content recording/playback apparatus 2 according to Embodiment 4. The content recording/playback apparatus 2 includes a first storage medium 1460, a second storage medium 1461, a first storage medium management section 1462, a second storage medium management section 1463, a decoder 1464, an encoder 1465, a control section 1466, a display section 1467, and an instruction receiving section 1468.

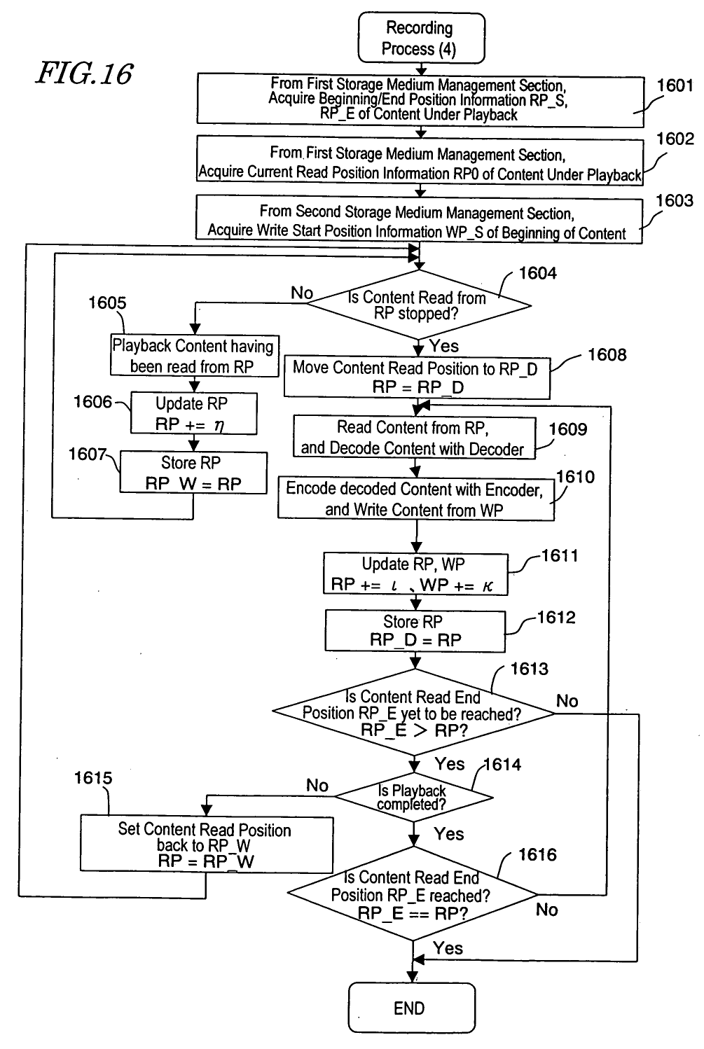

The content recording/playback apparatus 2 differs from the content recording/playback apparatus 1 of FIG. 1 in that the encoder 1465 for encoding a content which has been decoded by the decoder 1464 is included. The other constituent elements have generally similar functions to those of the namesake constituent elements of the content recording/playback apparatus 1. Therefore, while omitting the descriptions of the other constituent elements of the content recording/playback apparatus 2 herein, the functions of the respective constituent elements will be described in conjunction with the description of FIG. 16 given below.

FIG. 15 is a diagram showing access timing when a content recording/playback apparatus 2 of the present embodiment accesses a storage medium. While giving priority to reproduction/playback of a content A which is recorded on the first storage medium 1460, the content recording/playback apparatus 2 reads and records, in periods during which data for reproduction/playback of the content A is not read, an already-played-back portion at the point when a recording starting instruction for the content A is issued. In other words, a recording process similar to that of the content recording/playback apparatus 1 of Embodiment 2 is performed. However, when the data having been read is recorded onto the second storage medium 1461, the control section 1466 of the content recording/playback apparatus 2 determines whether it is possible to record the data as it is, and changes the process for recording depending on the result. Specifically, either a process of recording the data as it is, or a process of once decoding the content A having been read, encoding it back into a content having an recording-enabling attribute, and then recording it is executed. A recording-enabling attribute means having a data amount which is equal to or less than the vacant capacity of the second storage medium 1461, having a compression/encoding scheme which permits recording to the second storage medium 1461, and so on. These are determined in accordance with the type of the second storage medium 1461, the vacant capacity thereof, and the like.

For example, in the case where the content A recorded on the first storage medium 1460 is an MPEG-2 TS having a data amount of 3 gigabytes and a bit rate of 15 megabits/second, and where the second storage medium 1461 is a DVD-RAM having a vacant capacity of 4 gigabytes or more, it might appear that copying as it is would be possible, in terms of data amount alone. However, the bit rate actually exceeds the maximum bit rate (10.08 megabits/second) under the DVD standard, and the compression encoding scheme is not MPEG-2 PS of the DVD standard, so that it is impossible to perform copying as it is. Therefore, the control section 1466 determines whether or not the content A has an a recording-enabling attribute with respect to the second storage medium 1461, and further when converting into a content having a recording-enabling attribute, it is necessary to take into account not only the vacant capacity, type, compression encoding scheme, and the like of the second storage medium 1461 as the copying destination, but also the data amount, type, compression encoding scheme, and the like of the content A recorded on the first storage medium 1460 as the copying source.

The content recording/playback apparatus 2 performs a copying process based on the flowchart of FIG. 2, and performs a recording process similar to that of Embodiment 2 at step 209. Since the flowchart of FIG. 2 has been described in Embodiment 1, the description thereof is omitted in the present embodiment. However, the control section 1466 receives from the first storage medium management section 1462 the information of the compression/encoding scheme of the content A recorded on the first storage medium 1460, as well as a beginning read position, a current read position, and a final read position of the content A. From the second storage medium management section 1463, the control section 1466 receives the information of the type, vacant capacity, and beginning writable position of the second storage medium 1461. Based on such information, the control section 1466 is able to determine whether the content A can be recorded onto the second storage medium 1461 as it is. The details are as follows.

First, it is assumed that the beginning read position and the final read position of the content A recorded on the first storage medium 1460 are RP_S and RP_E, respectively; a read position of the content A at the start of recording is RP0; and a content-writable beginning position and a content-writable final position on the second storage medium 1461 are WP_S and WP_E, respectively. A capacity C1 of the content A is derived as follows.
C1=RP_{—}E−RP_{—}S (14)
A capacity C2 of the writable region of the second storage medium 61 is derived as follows.
C2=WP_{—}E−WP_{—}S (15)
Herein, only in the case where C1≦C2 and the compression/encoding method of the content A is identical to the compression/encoding scheme which enables recording onto the second storage medium 1461 (as determined based on the type of the second storage medium 1461) is it determined that the content A can be recorded onto the second storage medium 1461 as it is.

If the content A can be recorded as it is, the control section 1466 notifies to the first storage medium management section 1462 that the content A having been read from the first storage medium 1460 will be passed to the second storage medium 1461 without being decoded, and notifies to the second storage medium management section 1463 that the content A having been read from the first storage medium 1460 will be recorded onto the second storage medium 1461 without being encoded. Otherwise the process is identical to the process which is based on the flowchart of the content recording/playback apparatus according to Embodiment 2 (FIG. 11). Therefore, between the recording processes corresponding to step 209 of FIG. 2, the process in the case where the content A cannot be recorded as it is will be described below.

FIG. 16 is a flowchart showing the flow of a recording process of the content recording/playback apparatus of Embodiment 4. The process from steps 1601 to 1608 is identical to step 1101 to step 1108 in FIG. 11. Therefore, only the process from step 1609 on will be described. Whereas the current read position RP of an unplayed-back portion is increased by the data amount γ at step 1106, the data amount will be illustrated as η in step 1606. The current read position RP is advanced by the data size 77 which has been read in one time, thus being updated as shown by eq. (16) below.
RP←RP+η (16)
Through the processes of steps 1601 to 1603, the control section 1466 acquires information of the beginning read position RP_S and the final read position RP_E of the content A recorded on the first storage medium 1460, the read position RP0 of the content A at the start of recording, and the content-writable beginning position WP_S on the second storage medium 1461.

In the case where the content A cannot be recorded onto the second storage medium 1461 as it is and where the first storage medium 1460 is not performing a read of the content A for reproduction/playback, at step 1609, the control section 1466 notifies to the first storage medium management section 1462 that the content A having been read will be decoded and then passed to the second storage medium 1461, and notifies to the second storage medium management section 1463 that the content A having been read will be encoded and then recorded onto the second storage medium 1461. Then, the control section 1466 notifies encoding parameters to the encoder 1465. Herein, the encoding parameters are, for example, the compression/encoding method, bit rate, and the like. The content A having been read from the first storage medium 1460 is, after being decoded by the decoder 1464, displayed on the display section 1467 for reproduction. Then at step 1610, the encoder 1465 encodes the decoded content based on the encoding parameters notified from the control section 1466, and writes it to the current write position WP and later positions of the second storage medium 1461, via the second storage medium management section 1463.

For example, in the case where: the first storage medium 1460 is a HDD; the recorded content A is compression/encoded according to MPEG-2 TS; and the second storage medium 1461 is a DVD, the content A will be converted from MPEG-2 TS into MPEG-2 PS before recording. Even in the case where the content A recorded on the first storage medium 1460 is MPEG-2 PS in the above example, if its capacity is greater than the vacant capacity of the second storage medium 1461, it will be once decoded by the decoder 1464 so as to become recordable to the second storage medium 1461, and thereafter encoded by the encoder 1465 so as to be recorded onto the second storage medium 1461. The data recording process onto the second storage medium 1461 is similar to the process which has been described in connection with Embodiment 2.

At step 1611, the current read position RP is advanced by the data size ι which has been read in one time, and the current write position WP is advanced by the data size κ which has been written in one time. The current read position RP and the current write position WP are updated as shown by eq. (17) and (18) below.
RP←RP+ι (17)
WP←WP+κ (18)
At step 1612, the update value of RP is each stored as RP_D.

Thereafter, step 1613 to step 1616 are identical to the respective processes of steps 1112 to 1115 shown in FIG. 11. Therefore, the descriptions are omitted hereafter. Thus, the recording process of FIG. 16 is performed.

Note that, at step 1604 whose description is omitted, either a process for reproduction/playback of the content A or a process for recording of the playback-completed portion at the start of recording is performed with appropriate switching, as is the case with the content recording/playback apparatus 1 of Embodiment 1. When switching between the two processes, the control section 1466 notifies to the first storage medium management section 1462 so that the read position RP of the content A for the first storage medium 1460 should be set to either RP_W or RP_D. Between the two processes, priority is given to the reproduction/playback of the content A, which requires real time ability. Therefore, in a situation where a need to perform a read of the content A for reproduction/playback arises prior to a read for recording of the playback-completed portion at the start of recording or completion of its recording, the first storage medium management section 1462 notifies that indication to the control section 1466, and the control section 1466 interrupts the series of processes, and restarts the interrupted process after the read for reproduction/playback is completed.

Thus, the content recording/playback apparatus 2 of Embodiment 4 has been described. As described above, the control section 1466 is able to, while continuing reproduction/playback of the content A recorded on the first storage medium 1460, record the content A onto the second storage medium 1461. Furthermore, while giving priority to reproduction/playback of the content A recorded on the first storage medium 1460, the already-played-back portion at the point where a recording starting instruction for the content A was issued is read in periods during which an unplayed-back portion of the content A is not read. As a result, while continuing reproduction/playback of the content A, the content A under reproduction can be copied onto the second storage medium 1461. Since the already-played-back portion is concurrently recorded in the meantime of recording the content A for reproduction/playback, the waiting time after the end of playback and until completion of recording can be reduced.

Then, based on the amount and the compression/encoding scheme of the content A recorded on the first storage medium 1460, and based on a type, vacant capacity and the like, of the second storage medium 1461, the control section 1466 determines whether the content A recorded on the first storage medium 1460 can be recorded onto the second storage medium 1461 as it is. If it can be recorded, it is recorded as it is. If it cannot be recorded, the content A is once decoded by the decoder 1464, and again encoded by the encoder 1465 so as to be recorded. At this time, the encoder 1465 performs the encoding in such a manner as to result in a capacity and compression/encoding scheme which will enable recording to the second storage medium 1461. Thus, it is possible to arbitrarily decide the compression/encoding scheme for the contents recorded on the first storage medium 1460 and the second storage medium 1461.

In the content recording/playback apparatus of Embodiment 4, it is assumed that the data size which is read for reproduction/playback of the content A from the first storage medium 1460 is η, the data size which is read for recording of the content A is ι, and the data size of the content A to be recorded onto the second storage medium 1461 is κ. However, these values may be fixed or variable, and may be equal to or different from one another.

Thus, Embodiments 1 to 4 of the content recording/playback apparatus according to the present invention have been described above. In each embodiment, the decoder of the content recording/playback apparatus is illustrated as having a commonly-available decoding process function of decoding a single encoded data stream. However, it would also be possible to decode a plurality of encoded data streams. Hereinafter, two data streams which have been encoded based on the MPEG standard will be described as targets of decoding. Among the decoder 3 of Embodiments 1 to 3 and the decoder 1464 of Embodiment 4, the decoder 3 will be illustrated as an example.

The decoding process of an MPEG data stream can be generally classified into: (a) acquisition of parameters; (b) decoding of macro blocks, which are 16×16 pixel component elements; and (c) motion compensation. The (a) “parameters” are information which is necessary for the decoding of the pictures which compose video images, and include parameters which are acquired for each picture, parameters which are acquired with a frequency of once in several pictures, or parameters which are acquired once per data stream. Under the MPEG standard, only the displacement (amount of change) from an immediately previous image to the current image is encoded as information, thus reducing the necessary amount of information. At decoding, a displacement and furthermore a residual are applied to a decoding result of the immediately previous image (hereinafter referred to as a predicted reference image), whereby a current image (decoded image) is obtained. Note that the residual can be obtained from (b) “decoding of macro blocks”. Such a process is referred to as motion compensation.

FIG. 17 is a diagram showing the structure of a decoder 3 which decodes a plurality of encoded data streams. The decoder 3 receives a plurality of encoded data streams, as well as parameters (input information) concerning those data streams, and encodes a specific data stream for output. The input information is information which indicates whether a stream for reproduction/playback is to be decoded or a stream for recording is to be decoded. Note that the plurality of encoded data streams are to be input as a single data stream by being interleaved in such a manner that each is identifiable.

The decoder 3 includes a decoding process section 31 and an internal memory 32. The decoding process section 31 performs a decoding process for a data stream which is read from the first storage medium 10 and input thereto. The internal memory 32 retains parameters which are obtained in connection with the input data stream, as well as predicted reference images.

Hereinafter, descriptions will be given with reference to FIG. 1 as necessary. When a data stream containing a content A having been read from the first storage medium 10 is input to the decoder 3, the decoding process section 31 acquires from that data stream the parameters (input information) for decoding, and stores them to the internal memory. Since the first picture is an image which has been intra-coded (I picture), it can be decoded without requiring a predicted reference image. The decoding process section 31 retains the decoded image as a predicted reference image in the internal memory 32. The decoding process section 31 analyzes the next data of the data stream, and first determines whether the data is data that composes the previously-input stream or not. This determination is made based on the information received from the first storage medium management section 12.

If the received data is from the same data stream as the previous data stream, the data is decoded by using the aforementioned parameters and predicted reference image.

On the other hand, if the received data is not data from the same data stream as the previous data stream, the aforementioned parameter and predicted reference image are saved in other areas of the internal memory. Herein, it is assumed that the stream which was input first is a stream for reproduction/playback and is saved as parameters 1 and a predicted reference image 1.

The decoder 1464 which has been described in Embodiment 4 performs a decoding process for recording, in addition to a decoding process for reproduction/playback. Therefore, either a content A for reproduction/playback or a content A to be re-encoded for recording may be input to the decoder. In such a case, the following measures can be taken.

For example, in the case where it is necessary for the sake of recording to once decode an input data stream, the data which is the first to be input to the decoder can be decoded without requiring a predicted reference image. Under the MPEG standard, the beginning of the stream is an intra-coded picture, and therefore does not require a predicted reference image. In this case, the decoding process section 31 stores to the internal memory the parameters and predicted reference image up to that time.

Then, the next data of the data stream is input, and if this data is data for reproduction/playback, the decoding process section 31 saves the parameters and predicted reference image which are currently retained in the internal memory 32 into other areas, as parameters 2 and a predicted reference image 2. Then, based on the input information, the decoding process section 31 acquires the parameters and predicted reference image which are necessary for decoding the next data, and sets them to the internal memory 32. Note that, in the case where the parameters and predicted reference image have already been saved in the internal memory 32 as the parameter 1 and predicted reference image 1, these parameters and predicted reference image are set. Based on the parameters and predicted reference image having been set, the decoder decodes the received data. Thereafter, this process is repeated. As is clear from this description, in the case where a single decoder is used to decode a plurality of data streams, it is necessary, with respect to each stream, to retain parameters and a predicted reference image for motion compensation. Therefore, in order to store such data, extra memory capacity will be required within the decoder.

Note that a predicted reference image has a large size on memory, so that performing a save and restoration for each will lead to degradation in the performance of the entire decoder. Therefore, in practice, rather than performing a save and restoration for each, the storing addresses on the internal memory 32, when being accessed from the decoding process section 31, may be switched so as to correspond to the switching of the input data streams. Note that “save” and “restoration” also encompass the case where such a process is adopted. Although the above example assumes that the switching of the parameters and predicted reference image is performed responsive to completion of decoding of one picture, but the switching may be performed in the middle of the decoding of one picture. In that case, information indicating the state existing when a switching occurs and the progress of the process may also be saved and restored, together with the parameters and predicted reference image.

Thus, embodiments of the present invention have been described. The above embodiments were illustrated in such a manner that a start/end of copying takes place at a position in the content A that is being reproduced at the time when a copy starting/ending instruction is issued (i.e., a frame which is being reproduced). However, in the case where the data stream which is reproduced by the content recording/playback apparatus is encoded according to the MPEG standard, the position in the content A that is being reproduced may be shifted back or forth. For example, the content recording/playback apparatus may start copying from an intra-coded frame (Intraframe) which exists immediately before or after a position at which an instruction to start copying is given. This is in order to ensure that the beginning of the data stream after copying is always an Intraframe.

As a result, especially when starting a copy from the reproduction/playback position of the content A, it is possible, when reproducing the copied content, to avoid failure of the beginning frame to be decoded. More specifically, in the case of the MPEG-2 standard, a data stream is recorded in units each consisting of a plurality of frames beginning from an Intraframe, called GOP (Group of Pictures). Upon receiving a copy starting instruction, the content recording/playback apparatus will start copying from the beginning of an immediately subsequent GOP, and upon receiving a copy ending instruction, the content recording/playback apparatus will record the currently-copied GOP down to its end. Note that, under the DVD standard, the GOP period is about 0.5 seconds. Therefore, an Intraframe is inserted about every 0.5 seconds.

Moreover, the content recording/playback apparatus can also calculate the remaining time until completion of copying, and present it to the user. The remaining time until completion of copying is calculated by utilizing the “data amount of the data to be copied” and the “write rate to the second storage medium”. The specific details are as follows.

First, the “data amount of the data to be copied” will be described. The “data to be copied” means, in a content A to be copied, the data of any portion for which copying to the second storage medium has not been completed; before starting a copy, it represents the entire data amount of the content A, and during a copy, it represents the data amount of any portion for which copying has not been completed. The control section 15 which controls the write process grasps the data to be copied in units of VOBU, and its data amount can be obtained by utilizing the management information of the data stream. As has been described in connection with the control section 15 according to Embodiment 1, in a VOB, the address and data size of each VOBU, which is a data read unit, are described. Therefore, by identifying the individual VOBUs whose writing has not been completed, and calculating a sum total of the data sizes of the respective VOBUs by referring to the VOB, the data amount of the data to be copied is obtained.

On the other hand, the “write rate to the second storage medium” is a maximum write rate which is permitted to the second storage medium, or a maximum write rate of the hardware which performs writing, whichever is smaller (or if both are the same value, that same value). The control section can acquire the information of the write rate to the second storage medium from the second storage medium management section. Note that, even in the case where the second storage medium management section is provided in an external DVD drive apparatus or the like and cannot necessarily be regarded as a constituent element of the content recording/playback apparatus, the control section can still obtain the information of this rate. The reason is that the content recording/playback apparatus is usually equipped with driver software for controlling the operation of such an external DVD drive apparatus, and when the control section executes such driver software, the information of the write rate of the external DVD drive apparatus which is connected can be obtained.

The remaining time until completion of copying can be obtained by dividing the data amount of the data to be copied by the write rate to the second storage medium. For example, if the data amount of the data to be copied is 500 megabytes (4000 megabits) and the write rate to the second storage medium is 10 megabits per second, then the remaining time until completion of copying will be 400 seconds. If the calculated remaining time is displayed on the display section, the user can obtain an estimate of the point in time at which the copying will be completed, thus providing for improved convenience.

However, in the content recording/playback apparatus according to Embodiment 1 or the like, data which has been read for playback is written to the second storage medium, and therefore copying will not be completed before completion of playback. Therefore, when performing such a process, at least one of the following first and second predicted times can be displayed as the remaining time until completion of copying: a first predicted time, i.e., whichever is longer between the time obtained by the above division and the time until completion of playback; and a second predicted time, i.e., a sum of the time obtained by the above division and the time until completion of playback. For example, according to the processes of the content recording/playback apparatuses of Embodiments 1, 2, and 4, since copying of the reproduction/playback-completed portion at the start of copying is performed concurrently with reproduction/playback, the first predicted time may be displayed as the remaining time until completion of copying. On the other hand, according to the process of the content recording/playback apparatus of Embodiment 3, since copying of the reproduction/playback-completed portion at the start of copying is started after completion of reproduction/playback, the second predicted time may be displayed as the remaining time until completion of copying. In order to calculate the longest time that is expectable until completion of copying, irrespectively of the process of each embodiment, it would be possible to adopt whichever is longer between the first and second predicted times. Note that, assuming that recording of the content A is performed in such a manner that one VOBU contains one GOP, the time until completion of playback can be obtained by multiplication of the number of VOBUs to be reproduced and the reproduction time (about 0.5 seconds) of a GOP. In the case where reproduction/playback is interrupted, the data amount of the data whose copying has not been completed may be divided by the write rate to the second storage medium, and the remaining time until completion of copying may be recalculated and displayed again.

Furthermore, the above embodiments were illustrated in such a manner that when the content recording/playback apparatus receives a copy starting instruction, storage media are already in place at both the copying source and the copying destination. However, since it is also conceivable that the storage media may not be ready in place, it would be preferable to perform a determination process concerning presence or absence of a medium at the copying destination. Now, assume that a content A which is recorded on the first storage medium is to be copied to the second storage medium. If a copy starting instruction is received, the control section determines whether a storage medium is inserted at the copying destination or not, based on information from the second storage medium management section. If a storage medium is not inserted at the copying destination, a message indicating that “no medium is inserted” is displayed on the display section, and the process is ended. Moreover, based on a well-known technique, the second storage medium management section would also be able to determine whether a medium that is inserted at the copying destination is recordable or not. If a medium which is not recordable is inserted, a message indicating that “no recordable medium is inserted” is displayed on the display section, and the process is ended.

In the descriptions of the content recording/playback apparatuses of Embodiments 1 to 4, it was assumed that the first storage medium and the second medium are provided within the same apparatus. However, these media may be a hard disk of an external hard disk drive and a DVD of a rewritable-type DVD drive which are provided external to a PC serving as the content recording/playback apparatus and which are connected to the PC by utilizing the IEEE1394 interface, for example. In this case, the first medium management section which reads the data of the content A from the first medium is a controller and/or a connection interface section which gives reading instructions to the external drive and receives data read therefrom. The same is also true of the second medium management section.

In the content recording/playback apparatus of Embodiments 1 to 4, some or all of the functions of the first storage medium management section, the second storage medium management section, the decoder, the encoder, and the control section may be implemented by a CPU (central processing unit) not shown, based on a computer program. The computer program will cause the content recording/playback apparatus to perform the processes of the flowcharts shown in the drawings attached herein. By executing such a computer program, the content recording/playback apparatus can realize exactly the same operations as those in the above embodiments, and the same results can be obtained. By utilizing this program, the above-described content recording processes can be realized even with a general-purpose computer. Furthermore, even a conventional content recording/playback apparatus may be updated to this program in order to realize the aforementioned content recording processes. The computer program can be recorded on a magnetic storage medium such as a floppy disk, an optical storage medium such as an optical disk, or a semiconductor storage medium such as an IC card or a ROM cassette, and transmitted over a communication network such as the Internet.

### INDUSTRIAL APPLICABILITY

According to the present invention, there is provided a content recording/playback apparatus which, while continuing reproduction/playback of a content which is recorded on a given storage medium, can record that content onto another storage medium, and which can reduce the waiting time from completion of reproduction/playback until completion of recording. If the reading performance and writing performance of the storage media at both the recording source and the recording destination are sufficiently high, the recording of the content can be completed during the reproduction/playback of the content. On the other hand, even with a storage medium having a low writing performance and reading performance, the content recording/playback apparatus can record the content onto the storage medium at the recording destination while continuing reproduction/playback of the content. In this case, the waiting time from completion of reproduction/playback until completion of recording is the elapsed time from start of reproduction/playback until start of recording.

Moreover, according to the present invention, there is provided a content recording/playback apparatus which, even if storage media of different content compression/encoding schemes and different types are present, can record data that is recorded on one of the storage media onto another storage medium.

1. A content recording/playback apparatus for copying onto a second medium at least one portion of an encoded content recorded on a first medium, comprising:
a first medium management section for reading the encoded content from the first medium based on a reading instruction signal;
a decoder for decoding the encoded content read by the first medium management section, and outputting a decoded content;
a control section for controlling a read of the encoded content by generating the reading instruction signal, and receiving and outputting at least the decoded content output from the decoder;
a display section for reproducing the decoded content having been output from the control section; and
a second medium management section for, if the encoded content is recordable to the second medium, receiving the encoded content having been read by the first medium management section and recording the encoded content onto the second medium, during reproduction of the decoded content by the display section.

2. The content recording/playback apparatus of claim 1, wherein the content recording/playback apparatus copies from the beginning to end of the encoded content onto the second medium unless there is a designation of a range to be copied of the encoded content.

3. The content recording/playback apparatus of claim 1, further comprising a receiving section for, during reproduction of the decoded content by the display section, receiving from a user a starting instruction for starting copying and a position specifying instruction concerning a start position of copying, wherein
based on the starting instruction and the position specifying instruction, the control section generates a reading instruction signal for instructing on a read position of the encoded content and instructing to start reading the encoded content; and
based on the reading instruction signal, the first medium management section reads the encoded content from the read position as instructed.

4. The content recording/playback apparatus of claim 3, wherein the receiving section receives a position specifying instruction for specifying a beginning position of the encoded content as the start position of copying.

5. The content recording/playback apparatus of claim 3, wherein the receiving section receives a position specifying instruction for specifying a currently-reproduced position in the encoded content as the start position of copying.

6. The content recording/playback apparatus of claim 5, wherein, the encoded content includes an unreproduced portion corresponding to from the copy starting position to a last position and an already-reproduced portion from the beginning position to the copy starting position for which reproduction has been finished;
the control section generates a first reading instruction signal for instructing to read the unreproduced portion, and generates a second reading instruction signal for instructing to read the already-reproduced portion after reading of the unreproduced portion is finished;
the first medium management section reads the unreproduced portion based on the first reading instruction signal, and thereafter reads the already-reproduced portion based on the second reading instruction signal;
the decoder decodes and outputs the unreproduced portion having been read as the decoded content; and
the control section receives the unreproduced portion having been read and outputs the unreproduced portion to the second medium management section, and thereafter receives the already-reproduced portion having been read and outputs the already-reproduced portion to the second medium management section.

7. The content recording/playback apparatus of claim 5, wherein, the encoded content includes an unreproduced portion corresponding to from the copy starting position to a last position of the encoded content and an already-reproduced portion from the beginning position to the copy starting position of the encoded content for which reproduction has been finished;
the control section generates a first reading instruction signal for instructing to read a first data amount of the unreproduced portion, and after a read based on the first reading instruction signal is finished, generates a second reading instruction signal for instructing to read a second data amount of the already-reproduced portion, the control section repetitively generating the first reading instruction signal and the second reading instruction signal until reads of all of the unreproduced portion and the already-reproduced portion are finished;
the first medium management section reads the unreproduced portion based on the first reading instruction signal, and reads the already-reproduced portion based on the second reading instruction signal;
the decoder decodes the unreproduced portion having been read by the first medium management section, and outputs the unreproduced portion as the decoded content; and
the control section receives the unreproduced portion having been read and outputs the unreproduced portion to the second medium management section, and thereafter receives the already-reproduced portion having been read and outputs the already-reproduced portion to the second medium management section.

8. The content recording/playback apparatus of claim 1, further comprising an encoder for encoding the decoded content, wherein,
the decoder decodes the encoded content based on attribute information which represents a first attribute of the encoded content recorded on the first medium, and outputs the decoded content; and
if the encoded content is not recordable to the second medium, the encoder encodes the decoded content to generate an encoded content having a second attribute which is different from the first attribute, and outputs the encoded content to the second medium management section.

9. The content recording/playback apparatus of claim 1, wherein, the control section calculates a copy time to be required for copying, based on, in the at least one portion of the encoded content to be copied, a data amount of a portion whose copying to the second medium has not been completed, and on a write rate to the second storage medium; and
the display section displays a remaining time until completion of copying based on the copy time.

10. The content recording/playback apparatus of claim 9, wherein the control section further calculates a reproduction remaining time to be required for reproducing to the end the decoded content under reproduction, and displays whichever is longer between the reproduction remaining time and the copy time as the remaining time until completion of copying.

11. A content recording/playback method for copying onto a second medium at least one portion of an encoded content recorded on a first medium, comprising the steps of:
generating a reading instruction signal;
reading the encoded content from the first medium based on the reading instruction signal;
decoding the encoded content having been read, and generating a decoded content;
reproducing the generated decoded content; and
recording the encoded content onto the second medium during reproduction of the decoded content, if the encoded content is recordable to the second medium.

12. The content recording/playback method of claim 11, wherein the step of recording records from the beginning to end of the encoded content onto the second medium unless there is a designation of a range to be copied of the encoded content.

13. The content recording/playback method of claim 11, further comprising the steps of:
receiving from a user, during reproduction of the decoded content, a starting instruction for starting copying and a position specifying instruction concerning a start position of copying; and
generating a reading instruction signal for instructing on a read position of the encoded content and instructing to start reading the encoded content, based on the instruction and the position specifying instruction; and wherein
the step of reading reads the encoded content from the read position as instructed based on the reading instruction signal.

14. The content recording/playback method of claim 13, wherein the step of receiving the position specifying instruction receives the position specifying instruction for specifying a beginning position of the encoded content as the start position of copying.

15. The content recording/playback method of claim 13, wherein the step of receiving the position specifying instruction receives a position specifying instruction for specifying a currently-reproduced position in the encoded content as the start position of copying.

16. The content recording/playback method of claim 15, wherein, the encoded content includes an unreproduced portion corresponding to from the copy starting position to a last position and an already-reproduced portion from the beginning position to the copy starting position for which reproduction has been finished, the content recording/playback method further comprising the steps of:
generating a first reading instruction signal for instructing to read the unreproduced portion;
reading the unreproduced portion based on the first reading instruction signal;
generating a second reading instruction signal for instructing to read the already-reproduced portion after the unreproduced portion has been read; and
reading the already-reproduced portion based on the second reading instruction signal, after the unreproduced portion has been read, wherein,
the step of generating the decoded content decodes the unreproduced portion having been read and generates the decoded content; and
the step of recording onto the second medium records the already-reproduced portion having been read.

17. The content recording/playback method of claim 15, wherein, the encoded content includes an unreproduced portion corresponding to from the copy starting position to a last position of the encoded content and an already-reproduced portion from the beginning position to the copy starting position of the encoded content for which reproduction has been finished, the content recording/playback method further comprising the steps of:
generating a first reading instruction signal for instructing to read a first data amount of the unreproduced portion;
reading the first data amount of the unreproduced portion based on the first reading instruction signal;
generating a second reading instruction signal for instructing to read a second data amount of the already-reproduced portion, after the unreproduced portion has been read; and
repeating the step of generating the first reading instruction signal and the step of generating the second reading instruction signal until reads of all of the unreproduced portion and the already-reproduced portion are finished, wherein,
the step of generating the decoded content decodes the first data amount of the unreproduced portion having been read and generating the decoded content; and
the step of recording onto the second medium records the second data amount of the already-reproduced portion having been read.

18. The content recording/playback method of claim 11, further comprising the steps of:
decoding the encoded content based on attribute information which represents a first attribute of the encoded content, and outputting the decoded content for recording, if the encoded content is not recordable to the second medium; and
encoding the decoded content for recording to generate an encoded content having a second attribute which is different from the first attribute,
wherein the step of recording records the encoded content having the second attribute onto the second medium.

19. The content recording/playback method of claim 11, further comprising the steps of:
calculating a copy time to be required for copying, based on, in the at least one portion of the encoded content to be copied, a data amount of a portion whose copying to the second medium has not been completed, and on a write rate to the second storage medium; and
displaying a remaining time until completion of copying based on the copy time.

20. The content recording/playback method of claim 19, wherein,
the step of calculating further calculates a reproduction remaining time to be required for reproducing to the end the decoded content under reproduction; and
the step of displaying displays whichever is longer between the reproduction remaining time and the copy time as the remaining time until completion of copying.
